(19) United States
(12) Patent Application Publication
(10) Pub. No.: US 2026/0245174 A1
(43) Pub. Date: Aug. 20, 2026

(54) GENERATIVE MODELS FOR CARDIAC MAGNETIC RESONANCE IMAGING

(71) Applicant: The Curators of the University of Missouri, Columbia, MO (US)

(72) Inventors: Changyu Sun, Columbia, MO (US); Yu Wang, Columbia, MO (US); Talissa Altes, Columbia, MO (US)

(21) Appl. No.: 19/542,149

(22) Filed: Feb. 17, 2026

Related U.S. Application Data
(60) Provisional application No. 63/759,463, filed on Feb. 17, 2025.
(60) Provisional application No. 63/961,079, filed on Jan. 15, 2026.

(51) Int. Cl. G06T 3/4053; G06T 5/60; G06T 5/70

(52) U.S. Cl. CPC G06T 3/4053; G06T 5/60; G06T 5/70; G06T 2207/10088; G06T 2207/10104; G06T 2207/20081; G06T 2207/20084; G06T 2207/30048

(57) ABSTRACT

Systems and methods of generating high-resolution medical images of a subject are described. A computer-implemented method includes receiving at least one low-resolution medical image having a first resolution and generating, via a denoising machine learning model, a high-resolution image based on the low-resolution image. The high-resolution image has a second resolution higher than the first resolution. The denoising model includes a forward diffusion sub-model configured to transform a high-resolution image into a noise image by adding noise to an output forward image from a prior iteration. The denoising model further includes a reverse diffusion sub-model. In each second iteration, the reverse diffusion sub-model is configured to denoise an output reverse image from a prior iteration conditioned by the conditioning low-resolution image. Generating the at least one high-resolution medical image further includes inputting the low-resolution medical image into the denoising model and generating the at least one high-resolution image.

### CROSS-REFERENCE TO RELATED APPLICATIONS

This application claims the benefit of U.S. Provisional Patent Application Ser. No. 63/759,463, entitled “GENERATIVE MODELS FOR CARDIAC MAGNETIC RESONANCE IMAGING,” filed Feb. 17, 2025, and the content of which is incorporated herein in its entirety. This application also claims the benefit of U.S. Provisional Patent Application Ser. No. 63/961,079, entitled “GENERATIVE MODELS FOR CARDIAC MAGNETIC RESONANCE IMAGING,” filed Jan. 15, 2026, and the content of which is incorporated herein in its entirety.

### BACKGROUND OF THE INVENTION

The field of the disclosure relates generally to medical systems and methods, and more particularly, to systems and methods for generating high-resolution medical images from low-resolution medical images.

Magnetic resonance imaging (MRI) has proven useful in diagnosis of many diseases, such as coronary artery disease. MRI provides detailed images of soft tissues, abnormal tissues such as tumors, and other structures, which cannot be readily imaged by other imaging modalities, such as computed tomography (CT). Further, MRI operates without exposing patients to ionizing radiation experienced in modalities such as CT and x-rays.

Cardiovascular disease poses a significant health and economic burden worldwide. It is closely associated with hypertension, diabetes, obesity, smoking, lack of exercise, and poor diet, all of which may lead to macro- and microvascular abnormalities in the heart. One such abnormality is coronary artery stenosis, which reduces the local supply of oxygen and nutrients to the myocardium and results in reduced levels of myocardial perfusion, and may lead to more severe conditions and irreversible damage to myocardial tissues. Thus, accurate evaluation of myocardial perfusion abnormalities in patients with these risk factors is needed. Cardiac perfusion MRI, also known as myocardial perfusion imaging, is a non-invasive scan that evaluates the heart muscle's blood flow. While magnetic resonance myocardial perfusion imaging has become more accurate at evaluating the myocardial microcirculation, improvements are still needed. For example, sufficient spatial resolution is needed to detect subtle perfusion abnormalities. However, achieving enough spatial resolution (<3.0 mm) and extensive slice coverage is challenging under high heart rate conditions. Moreover, capturing a sufficient number of slices (e.g., ≥3 slices) within a short acquisition window further complicates the ability to fully resolve both motion and perfusion dynamics. Accordingly, an improved cardiac perfusion MRI is needed.

### SUMMARY OF THE INVENTION

In one aspect, a computer-implemented method of generating high-resolution medical images of a subject is provided. The computer-implemented method includes receiving at least one low-resolution medical image, the at least one low-resolution medical image having a first resolution. The computer-implemented method further includes generating, via a denoising machine learning model in a denoising diffusion probabilistic model, at least one high-resolution image based on the at least one low-resolution medical image. The at least one high-resolution medical image has a second resolution higher than the first resolution. The denoising diffusion probabilistic model includes a forward diffusion sub-model configured to transform an input high-resolution medical image into a noise image by adding noise to an output forward image from a prior iteration in a plurality of first iterations. The denoising diffusion probabilistic model further includes a reverse diffusion sub-model including the denoising machine learning model. The reverse diffusion sub-model is configured to reconstruct the input high-resolution medical image via the denoising machine learning model in a plurality of second iterations based on the noise image while being conditioned by a conditioning low-resolution image. In each second iteration of the plurality of second iterations, the reverse diffusion sub-model is configured to denoise, via the denoising machine learning model, an output reverse image from a prior iteration conditioned by the conditioning low-resolution image. Generating the at least one high-resolution medical image further includes inputting the at least one low-resolution medical image into the denoising machine learning model and generating the at least one high-resolution medical image as at least one output from the denoising machine learning model. The computer-implemented method further includes outputting the at least one high-resolution medical image.

In another aspect, an image processing computing device for generating high-resolution medical images of a subject is provided. The imaging processing computing device includes at least one processor in communication with the at least one memory device. The at least one processor is programmed to receive at least one low-resolution medical image, the at least one low-resolution medical image having a first resolution. The at least one processor is further programmed to generate, via a denoising machine learning model in a denoising diffusion probabilistic model, at least one high-resolution medical image based on the at least one low-resolution medical image, the at least one high-resolution medical image having a second resolution higher than the first resolution. The denoising diffusion probabilistic model includes a forward diffusion sub-model configured to transform an input high-resolution medical image into a noise image by adding noise to an output forward image from a prior iteration in a plurality of iterations. The denoising diffusion probabilistic model further includes a reverse diffusion sub-model including the denoising machine learning model. The reverse diffusion sub-model is configured to reconstruct the at least one high-resolution medical image via the denoising machine learning model in the plurality of iterations based on the noise image while being conditioned by a conditioning low-resolution image. In each iteration, the reverse diffusion sub-model is configured to denoise, via the denoising machine learning model, an output reverse image from the prior iteration conditioned by the conditioning low-resolution image. Generate the at least one high-resolution medical image further includes input the at least one low-resolution medical image into the denoising machine learning model and generate the at least one high-resolution medical image as at least one output from the denoising machine learning model. The at least one processor is further programmed to output the at least one high-resolution medical image.

In one more aspect, one or more non-transitory computer-readable media for generating high-resolution medical images of a subject is provided. The one or more non-transitory computer-readable media include one or more instructions stored thereon that, in response to being executed, cause a system to receive at least one low-resolution medical image, the at least one low-resolution medical image having a first resolution. The one or more non-transitory computer-readable media further cause the system to generate, via a denoising machine learning model in a denoising diffusion probabilistic model, at least one high-resolution medical image based on the at least one low-resolution medical image, the at least one high-resolution medical image having a second resolution higher than the first resolution. The denoising diffusion probabilistic model includes a forward diffusion sub-model configured to transform an input high-resolution medical image into a noise image by adding noise to an output forward image from a prior iteration in a plurality of first iterations. The denoising diffusion probabilistic model further includes a reverse diffusion sub-model including the denoising machine learning model. The reverse diffusion sub-model is configured to reconstruct the input high-resolution medical image via the denoising machine learning model in a plurality of second iterations based on the noise image while being conditioned by a conditioning low-resolution image. In each second iteration of the plurality of second iterations, the reverse diffusion sub-model is configured to denoise, via the denoising machine learning model, an output reverse image from a prior iteration conditioned by the conditioning low-resolution image. Generate the at least one high-resolution medical image further includes input the at least one low-resolution medical image into the denoising machine learning model and generate the at least one high-resolution medical image as at least one output from the denoising machine learning mode. The one or more non-transitory computer-readable media further cause the system to output the at least one high-resolution medical image.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a flow chart of an example method of generating high-resolution medical images.

FIG. 2 is a schematic diagram of an example magnetic resonance imaging (MRI) system machine.

FIG. 3A is a schematic diagram of a neural network model.

FIG. 3B is a schematic diagram of a neuron in the neural network model shown in FIG. 3A.

FIG. 4 is a block diagram of an example user computing device.

FIG. 5 is a block diagram of an example server computing device.

FIGS. 6A-6D illustrate general methodology of methods of the disclosure.

FIG. 6A illustrates the framework of a conditional denoising diffusion model. The forward diffusion process q (left to right) gradually add noise to the high-resolution image y₀ over T steps until it converges to pure Gaussian noise y_{T}. The reverse diffusion process p (right to left) iteratively denoises the noisy images, conditioned on the low-resolution (LR) image x. FIG. 6B shows that a cascade of TagGens, referred to an example method described herein, is constructed, alternating between a TagGen and data consistency (DC) processes in k-space. FIG. 6C shows a strategy for generation of synthetic training data. Retrospectively acquired high-resolution (HR) Tagging image (a) were transformed to Fourier space (b). In k-space, the center 30% phase-encoding lines were maintained (c) and the outer space were zero padded (d) to mimic a fully sampled LR acquisition. The same center cropping was applied to the HR image (a) and simulated LR image (e) to get synthetic paired LR-HR Tagging dataset (f, g). FIG. 6D is an illustration of the undersampling pattern depicted with a binary mask in k-space with low-resolution 30% and Generalized Auto-calibrating Partially Parallel Acquisitions (GRAPPA-3). ACS lines were acquired in a separated scan. White lines represent the acquired lines (rate-3), while dark lines indicate those that were not acquired.

FIG. 7 shows a depiction of the denoising U-Net architecture. The network takes in a two-channel input, where one channel represents the low-resolution condition image and the other contains the noisy image at time step t. The output is the denoised image at the subsequent time step t−1. The U-Net architecture includes convolutional layers, group normalization, Swish activation, residual connections, and pooling layers. A convolution layer and two linear layers were used as the image encoder for the inputs. At the bottleneck, an additional self-attention layer was applied.

FIG. 8 shows comparisons of TagGen with one single model and with a cascade of two to five models for super-resolving prospectively acquired low-resolution MR tagging images from a patient with a nominal rate-10 acceleration of two-chamber views. The first column shows the original low-resolution (LR) MR tagging images, acquired using 30% central phase encoding lines and GRAPPA-3 reconstruction. Subsequent columns display the results from TagGen with a single model (second column) and a cascade of two to five models (third-sixth columns). The last column shows high-resolution (HR) MR tagging images at the same slice locations but acquired during a separate breath-hold. All TagGen models, both single and cascaded, enhanced image sharpness and clarity. For the cascade length, two radiologists selected N=3 through visual assessment of N=1 to 5 of all prospective data.

FIG. 9 shows comparisons of REGAIN, a known method, and TagGen for super-resolution of synthetic low-resolution MR tagging images for a patient with a rate-3.3 acceleration of the two-chamber view at end-diastole and end-systole. The low-resolution (LR) MR tagging images in the first column were simulated from the high-resolution (HR) reference images in the last column, using 30% central phase encoding lines (R=3.3) and zero-padding reconstruction. Low-resolution images were super-resolved by REGAIN (second column) and TagGen (third column), respectively. Both REGAIN and TagGen have improved image sharpness compared to the LR images, with TagGen demonstrating superior tagline quality, sharper lines, and overall better image quality.

FIG. 10 shows comparisons of REGAIN and TagGen for super-resolution of prospectively acquired low-resolution MR tagging images for a volunteer with a rate-10 acceleration of the two-chamber view at 1.5T scanner. The first column illustrates low-resolution (LR) MR tagging images, acquired using a combination of 30% central phase encoding lines and GRAPPA-3 (generalized autocalibrating partially parallel acquisitions 3) reconstruction. Low-resolution images were reconstructed by REGAIN (second column) and TagGen (third column), respectively. The last column represents high-resolution MR tagging images at the matched slice location in a different breath-hold as references. Both REGAIN and TagGen improved image sharpness compared to the LR images, with TagGen demonstrating superior tagline quality, sharper lines, and overall better image quality.

FIG. 11 shows comparisons of REGAIN and TagGen for super-resolving prospectively acquired low-resolution MR tagging images for a patient with a nominal rate-10 acceleration of the four-chamber view at 3T scanner. The first column displays low-resolution (LR) MR tagging images, acquired using a combination of 30% central phase encoding lines and GRAPPA-3 reconstruction. Low-resolution images were reconstructed by REGAIN (second column) and TagGen (third column), respectively. The last column represents high-resolution MR tagging images at the matched slice location in a different breath-hold as references. Both REGAIN and TagGen improved image sharpness compared to the LR images, with TagGen demonstrating superior tagline quality, sharper lines, and overall better image quality.

FIGS. 12A-12C show quantitative comparisons of REGAIN and TagGen for super-resolution of prospective MR tagging images with central 30% k-space and GRAPPA-3. The evaluation was performed on 18 slices from 6 independent subjects and scored by two radiologists. TagGen demonstrated significantly better performance on all three metrics compared to REGAIN, with higher tag grid quality (A), signal-to-noise ratio (B), and overall image quality (C). Tag grid quality: REGAIN, 2.64±0.41; TagGen, 4.19±0.35 (P<0.05). Signal-to-noise ratio: REGAIN, 2.86±0.41; TagGen, 3.75±0.35 (P<0.05). Overall image quality: REGAIN, 2.64±0.38; TagGen, 3.94±0.16 (P<0.05).

FIG. 13 shows validation of TagGen for super-resolution of prospectively acquired low-resolution MR tagging images from a patient of two-chamber view on a 3T scanner, with 6 mm tagging line spacing. According to Equation 8 in Detailed Description, the relative location of the harmonic peak for 6 mm tagging is 1.5 mm/6 mm×\sqrt{2}=35.4%, which lies outside our standard 30% acquisition scheme. Therefore, the low-resolution acquisition was adjusted to 40% of k-space for 6 mm tagging line spacing to cover the harmonic peak region. The first row shows the low-resolution (LR) MR tagging images at end-diastole and end-systole, acquired with 40% central k-space acquisition and GRAPPA-3 reconstruction. The second row displays the corresponding super-resolved images generated by TagGen. TagGen showed improved image sharpness compared to the LR images, demonstrating the model's capability to handle various tagging line spacings.

FIG. 14 illustrates a framework of a synthetic data pipeline. High-resolution myocardial perfusion images are processed to generate synthetic low-resolution images. This involves Fast Fourier transform (FFT) of the perfusion image, taking the center k-space lines, applying zero-padding, and performing an inverse FFT (IFFT), resulting in paired high-resolution (HR) and low-resolution (LR) images.

FIGS. 15A-15C illustrate the conditional denoising diffusion model and the denoising U-Net architecture. FIG. 15A illustrates a forward diffusion process q (left to right) gradually adds noise to the high-resolution image y₀ over T steps or iterations until it converges to pure Gaussian noise y_{T}. The reverse diffusion process p (right to left) iteratively denoises the noisy images, conditioned on the low-resolution (LR) image x, to recover the high-resolution image. FIG. 15B illustrates that input to the U-Net includes two channels: the LR image x concatenated with the noisy image yₜ at timestep t. The model outputs the denoised image yₜ₋₁, which is used as input in the next iteration. FIG. 15C is a detailed depiction of the denoising U-Net architecture. The network takes in a two-channel input, where one channel represents the low-resolution condition image and the other contains the noisy image at time step t. The output is the denoised image at the subsequent time step t−1. The U-Net architecture includes convolutional layers, group normalization, Swish activation, residual connections, and pooling layers. A convolution layer and two linear layers were used as the image encoder for the inputs. At the bottleneck, an additional self-attention layer was applied.

FIG. 16 shows a comparison of myocardial perfusion images across perfusion phases using synthetic test data. From left to right, the images show the perfusion image at baseline, peak right ventricle (RV), peak left ventricle (LV), and peak myocardium (Myo). Each column represents different time points, illustrating the progression of contrast perfusion through the myocardium, highlighting key cardiac phases with distinct contrast enhancement in the RV, LV, and myocardial tissue. The rows show the low-resolution images, Generative Adversarial Network (GAN)-based images, PerfGen (an example method described herein) super-resolved perfusion images, and high-resolution reference images.

FIG. 17A shows comparison of GAN-based, super-resolved images and high-resolution perfusion images across different slice locations. From left to right, the myocardial perfusion images are shown at the base, midventricular, and apical slice locations. The top row showed low-resolution images, the third row showed PerfGen super-resolved images, and the bottom row showed the corresponding high-resolution reference images. This comparison highlights the effectiveness of PerfGen in enhancing image resolution across various slice locations of the heart. FIG. 17B shows signal-t plots illustrating the signal intensity of the basal slice in (A) in terms of the LV myocardial region, LV blood pool and RV blood pool changes over time. The spatially super-resolved images (SR-S, orange curve) aligns better with the reference high-resolution spatial images (HR-S) than the acquired low-resolution spatial images (LR-S). LV: left-ventricular; RV: right-ventricular.

FIG. 18 shows a comparison of cross-section profile along time plots corresponding to low-resolution, PerfGen and reference high-resolution for the patient in FIGS. 17A & 17B. PerfGen presents better temporal fidelity than zero-padded low-resolution images compared to the high-resolution reference x-t plots.

FIG. 19 shows example images from a retrospective patient undergoing Regadenoson stress perfusion imaging with inducible myocardial ischemia with a moderate sized defect in the basal septum and a small defect in the inferolateral wall. Low-resolution (LR) images, GAN-based super-resolution, PerfGen, and high-resolution (HR) images were compared as reference for image quality and their ability to illustrate perfusion defects. LR images, used as the baseline, appear blurred but indicates perfusion defects in the septum. The GAN-based super-resolution method improves image sharpness but shows slight mismatches with the HR reference in terms of image details in myocardial regions, with potentially reduced fidelity in depicting the small inferolateral wall perfusion defects (indicated by red arrows). PerfGen demonstrates greater visual similarity to the HR reference, more accurately highlighting perfusion defects in similar regions with higher fidelity.

FIGS. 20A-20C show a quantitative comparison of GAN and PerfGen super-resolved myocardial perfusion images for nine tested datasets. Boxplots show the normalized root mean square error (nRMSE) (FIG. 20A), peak signal-to-noise ratio (PSNR) (FIG. 20B), and structural similarity index (SSIM) for zero-padded and PerfGen images (FIG. 20C). PerfGen demonstrates a significant improvement in all metrics, with lower nRMSE, higher PSNR, and higher SSIM compared to zero-padded images, with a reduction in nRMSE by approximately 20%, an increase in PSNR by 6%, and an improvement in SSIM by 3%. Statistical significance is indicated by the asterisks.

FIG. 21 shows a comparison of low-resolution, super-resolved, and LGE images for one prospectively acquired myocardial perfusion dataset. The first row illustrates the low-resolution perfusion images, followed by the super-resolved images in the third row. The last row shows the corresponding LGE images at similar slice locations. The super-resolved perfusion images highlight perfusion defects that closely match the locations of defects observed in the LGE images, demonstrating the ability of super-resolution to recover and enhance important diagnostic features. This figure also shows how the combination of low-resolution acquisition of 35% phase resolution and GRAPPA-2 may improve slice coverage, with five slices acquired and 2.86-fold higher temporal resolution for this patient.

FIG. 22A shows a comparison of low-resolution (LR) perfusion images, GAN-based super-resolved images and PerfGen super-resolved images across different perfusion slices for one prospectively acquired test data. This figure shows the super-resolved images by PerfGen compared with low-resolution images using zero-padding and super-resolved images by GAN at different slice locations using GRAPPA-3 and LR of 35% phase resolution. PerfGen demonstrate improved contrast and details in the images than zero-padding images and GAN super-resolved images. FIG. 22B illustrates signal-time plots showing the intensity changes over time for the basal slice in FIG. 22A in terms of the LV myocardial region, LV blood pool, and RV blood pool. The acquired LR spatial image achieves 4.3-fold higher temporal resolution (green curve) compared to routine reference temporal resolution. PerfGen super-resolved spatial images maintain this high temporal resolution (orange curve) while capturing more detailed myocardial perfusion dynamics than zero-padding and GAN super-resolved images. The synthetic curve represents 4.3-fold lower temporal resolution, simulating a 2-fold accelerated acquisition. The higher temporal resolution (green, purple and orange curves) enables more accurate tracking of rapid perfusion changes compared to the smoother dynamics observed in the low temporal resolution curve (SR-S & LR-T blue curve) as supported by the comparison with low spatial resolution images (LR-S & HR-T, green curve). LV, left-ventricular; RV, right-ventricular; LR-S, low spatial resolution images; HR-T, high temporal resolution images; SR-S, super-resolved spatial images: low temporal resolution images.

FIG. 23 shows quantitative comparisons of GAN and PerfGen methods for super-resolution of prospective MR tagging images, evaluated on 9 prospective subjects and scored by two experts. PerfGen demonstrated significantly better performance than zero-padding in sharpness and overall image quality. Sharpness scores were 3.89±0.22 for zero-padding and 4.89±0.22 for PerfGen (P<0.05), while overall image quality scores were 3.83±0.35 for GAN and 4.89±0.22 for PerfGen (P<0.05). Correlations of the two experts for metrics were 0.77 for sharpness and 0.57 for overall image quality.

### DETAILED DESCRIPTION

The present disclosure relates to methods of, and systems for, providing high-resolution, cardiac magnetic resonance (CMR) imaging that maintains high image quality and diagnostic quality. More specifically, the present disclosure provides a unified framework that combines generative modeling approaches such as Denoising Diffusion Probabilistic Models (DDPM), Denoising Diffusion Implicit Models (DIDIM), and flow matching models, that enhances and accelerates CMR imaging. Such a framework enables transformation of low-resolution (LR) images into high-resolution (HR) outputs having preserved spatial, temporal, and anatomical fidelity. As used herein, a resolution in an LR image and an HR image refers to the acquisition resolution or the resolution of acquisition of the image in the k-space. For example, the LR image is acquired with a first resolution of 64×64 in the k-space, where the k-space is sampled or acquired with a resolution of 64 in the kₓ direction and a resolution of 64 in the in the k_{y} direction. The HR image has a second resolution in the k-space of 128×128, where the k-space is sampled or acquired with a resolution of 128 in the kₓ direction and a resolution of 128 in the k_{y} direction. The LR image and the HR image may have the same matrix sizes in the image domain, where the LR image and the HR image have the same number of pixels in the x dimension and the same number of pixels in the y dimension. Two dimensional (2D) images are described herein as examples for illustration purposes only. Systems and methods described herein may be applied in three-dimensional (3D) images to increase the resolution of acquisition in the slice-selection direction or the k_{z} direction. Systems and methods described herein are advantageous in increasing acquisition resolutions of images, where the output images have an increased acquisition resolution while the input images are acquired with a reduced acquisition resolution, thereby reducing image acquisition time while maintaining or increasing image quality. Systems and methods described herein are also advantageous in reducing or removing artifacts in the images, and/or increasing contrast in the images.

Unless defined otherwise, all technical and scientific terms used herein have the same meaning as commonly understood by one of ordinary skill in the art to which the disclosure belongs. Although any methods and materials similar to or equivalent to those described herein may be used in the practice or testing of the present disclosure, the preferred materials and methods are described below.

The disclosure includes systems and methods of CMR imaging of a subject. As used herein, a subject is a human, an animal, or a phantom, or part of a human, an animal, or a phantom, such as an organ or tissue. MR images are described as examples for illustration purposes only. Systems and methods described herein may be applied to other medical images and other medical imaging modalities, such as positron-enhanced tomography (PET), or PET-MR. Noise, artifacts, other undesired signals, or any combination thereof is collectively referred to as noise. Artifacts may be caused by under-sampling, eddy currents, physiological noise, B0 drifts, B0 and/or B1 inhomogeneity, or other system imperfections. Reducing or removing noise is collectively referred to as reducing noise or denoising. A denoised image is an image having noise reduced. Method aspects will be in part apparent and in part explicitly discussed in the following description.

The systems and methods described herein address the long-felt need in the field for accelerated, high-resolution CMR imaging while maintaining high image quality and diagnostic quality. By integrating these generative approaches, it provides flexible solutions for various imaging modalities, including cine MRI, myocardial perfusion MRI, late gadolinium enhancement (LGE) MRI, tagging MRI, and other similar MRI applications. This framework may be used to enhance resolution, reduce artifacts, and optimize acquisition time across a wide range of MRI-based diagnostic and research applications. Systems and methods described herein provide solutions that balance spatial resolution, temporal fidelity, and slice coverage, offering a new way for efficient and high-quality myocardial perfusion MRI.

Systems of methods described herein address the need by including at least the following techniques:

First, conditional Diffusion-Based Generative Models for CMR (e.g., Denoising Diffusion Probabilistic Models (DDPM), Denoising Diffusion Implicit Models (DDIM)):
Systems and methods described herein utilize low-resolution (LR) images as conditional inputs to guide the generative process, ensuring that high-resolution (HR) outputs retain anatomical and physiological fidelity aligned with the LR input.
The example embodiments only need to acquire low-resolution (LR) MRI images during the scan, which highly accelerate and optimize the clinical workflow by reducing scan time to one-third or even less.
This approach is complementary to other acceleration techniques such as parallel imaging, compressed sensing, or deep learning-based reconstructions, as the LR images obtained from these methods may be further enhanced using this generative framework.
Systems and methods described herein are suitable for reconstructing fine-grained details and complex patterns, such as myocardial boarders of cine MRI, myocardial tagging grids, contrast variations and boundaries, from limited or accelerated data with blurring or images with artifacts.

Second, flow matching models with conditional inputs:
Systems and methods described herein leverage continuous transformation techniques to directly map conditional LR inputs to HR outputs, reducing reliance on iterative sampling steps.
The approach may be directly applied to the undersampled complex data for removing the undersampling artifacts using the parallel imaging results such as CG-SENSE as the condition. Inference of increased speed is ensured, compared to known diffusion models, while maintaining the anatomical consistency dictated by the LR condition.
Systems and methods described herein are particularly effective for real-time workflows, where conditional input guidance enables accurate HR reconstructions within stringent time constraints.

Third, hybrid conditional approaches:
Systems and methods described herein integrate conditional diffusion models with flow matching for tailored solutions, combining the training stability and detail recovery of diffusion methods with the speed and efficiency of flow matching.
Systems and methods described herein enhance versatility by adapting these hybrid models across various CMR modalities, including cine MRI, myocardial perfusion MRI, tagging MRI, and late gadolinium enhancement (LGE).
Systems and methods described herein exploit the physical properties of MR data (e.g., k-space harmonics) as additional conditional inputs to further refine HR reconstructions.

Systems and methods described herein have the following technical advantages over at least some known methods:
Systems and methods described herein include a unified framework, which provides a comprehensive solution adaptable to all major CMR modalities, including cine MRI, perfusion MRI, LGE MRI, and tagging MRI, enabling consistent enhancements across diverse imaging applications.
Enhanced Image Quality. Additionally, the example embodiments allow for enhanced image quality, where superior resolution and clarity are provided, compared to traditional interpolation methods and GAN-based approaches, generating sharper, artifact-free images with high anatomical accuracy and improved diagnostic reliability. The example embodiments further improve efficiency and speed of technical processes, where computational overhead is reduced through flow-matching or DDIM techniques, enabling rapid inference and making real-time applications in clinical workflows feasible.
Seamless Integration. Furthermore, the example embodiments allow for seamless integration that provides easy integration with existing acceleration techniques such as parallel imaging, compressed sensing and deep learning reconstruction outputs, supporting hybrid approaches to maximize both acquisition speed and image quality.

The framework of the example embodiments is versatile and extends beyond tagging MRI, perfusion MRI, cine MRI, and LGE MRI. It is applicable to other advanced CMR techniques, such as flow imaging and tissue characterization (e.g., T1 and T2 mapping), enhancing spatial and temporal resolution while maintaining diagnostic accuracy across diverse modalities.

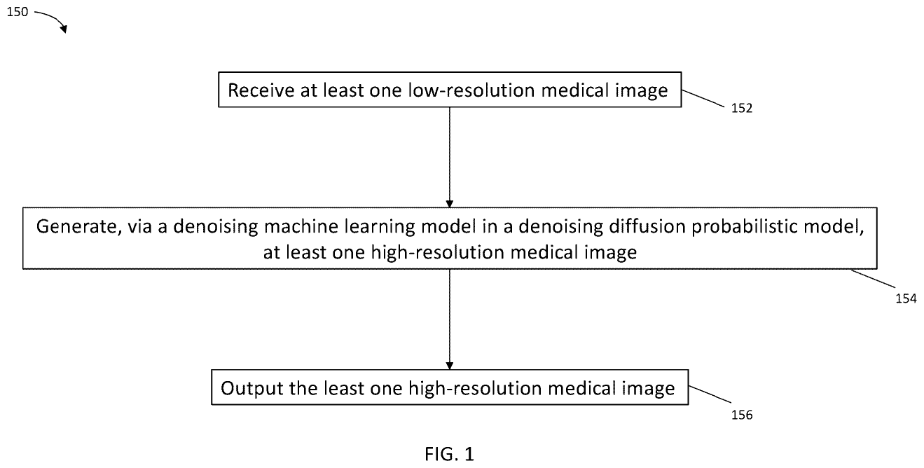

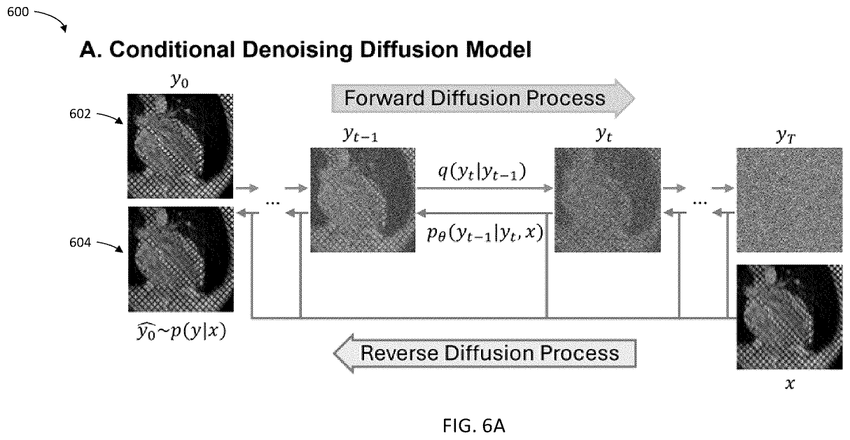

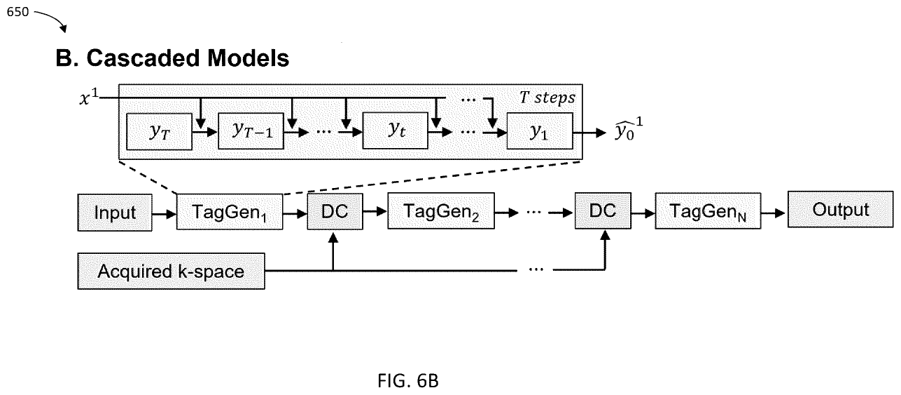

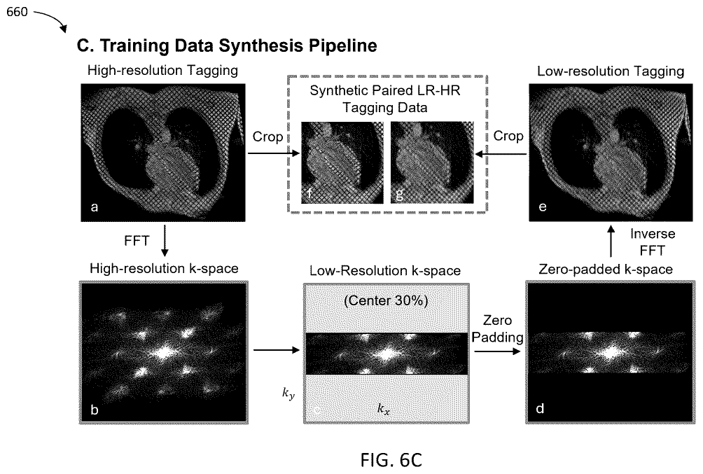

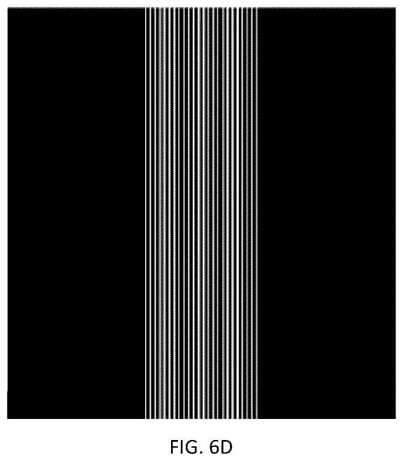

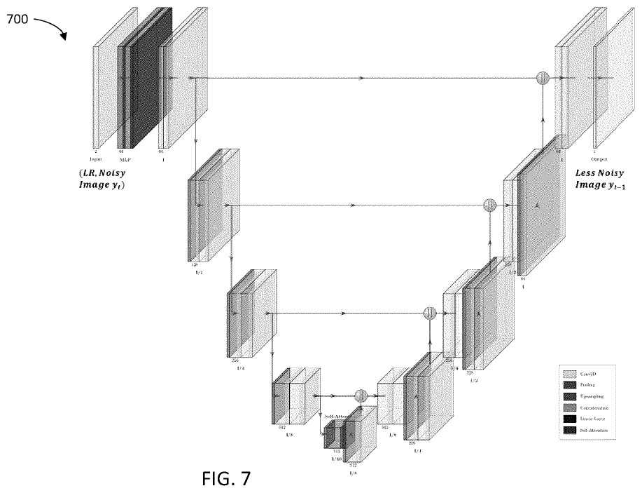

FIG. 1 is a flow chart of an example method 150 of generating high-resolution medical images of a subject. Method 150 includes receiving 152 at least one low-resolution medical image, the at least one low-resolution medical image having a first resolution. The method also includes generating 154, via a denoising machine learning model in a denoising diffusion probabilistic model, at least one high-resolution medical image based on the at least one low-resolution medical image, the at least one high-resolution medical image having a second resolution higher than the first resolution. A schematic diagram of an example denoising diffusion probabilistic model 600 is shown in FIG. 6A (described in further detail later). A schematic diagram of an example denoising machine learning model 700 is shown in FIG. 7 (described later). Denoising diffusion probabilistic model 600 includes a forward diffusion sub-model 602 configured to transform an input high-resolution medical image into a noise image by adding noise to an output forward image from a prior iteration in a plurality of iterations. Denoising diffusion probabilistic model 600 further includes a reverse diffusion sub-model 604 including the denoising machine learning model, reverse diffusion sub-model 604 configured to transform an input high-resolution medical image into a noise image by adding noise to an output forward image from a prior iteration in a plurality of first iterations. The reverse diffusion sub-model 604 further includes the denoising machine learning model, the reverse diffusion sub-model 604 configured to reconstruct the input high-resolution medical image via the denoising machine learning model in a plurality of second iterations based on the noise image while being conditioned by a conditioning low-resolution image, wherein in each second iteration of the plurality of second iterations, the reverse diffusion sub-model is configured to denoise, via the denoising machine learning model, an output reverse image from a prior iteration conditioned by the conditioning low-resolution image. Generating 154 the at least one high-resolution medical image further includes inputting the at least one low-resolution medical image into the denoising diffusion probabilistic model 600 and generating the at least one high-resolution medical image as at least one output from the denoising machine learning model. Method 150 further includes outputting 156 the at least one high-resolution medical image.

The number of first iterations may be the same as the number of second iterations. In some embodiments, the number of first iterations is different from the number of second iterations.

In the example embodiment, generating 154 the at least one high-resolution medical image further includes cascading 650 (FIG. 6B, described later), in a plurality of stages, the generating by in each stage, inputting the noise image and at least one output stage image from a prior stage into the denoising machine learning model, and generating at least one increased-resolution image as the at least one output from the denoising machine learning model. A schematic diagram of an example method of cascading 650 is shown in FIG. 6B. The at least one high-resolution medical image is the at least one output stage image at a final stage.

In the example embodiments, method 150 further includes training the denoising machine learning model using a training image dataset. The training image dataset includes low-resolution training images and corresponding high-resolution training images, the corresponding high-resolution training images being ground truth in training. The low-resolution training images are generated by removing peripheral phase-encoding k-space data of the corresponding high-resolution training images. FIG. 6C is a schematic diagram of generating 660 training images. In some embodiments, 70% the peripheral phase-encoding k-space data are removed in generating the low-resolution training images.

In the example embodiment, the at least one low-resolution medical image is a tagging MR image. In another example embodiment, the at least one low-resolution medical image is a perfusion MR image.

In some embodiments, generating the at least one high-resolution medical image further includes generating the at least one high-resolution medical image while scanning a subject to acquire the at least one low-resolution medical image of the subject.

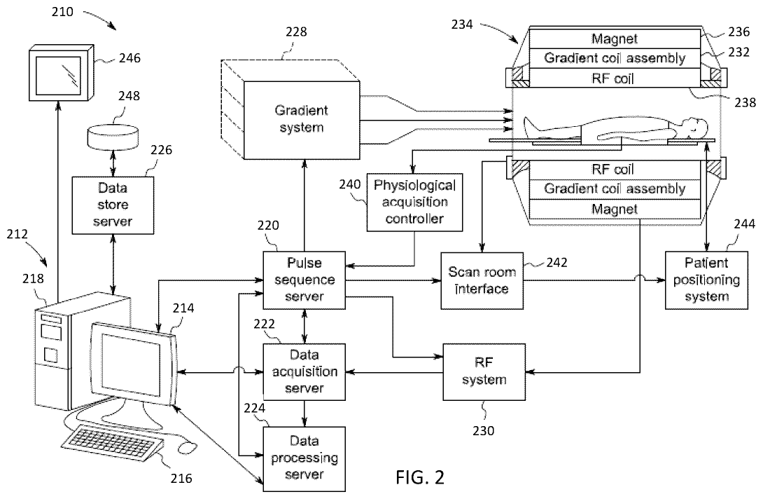

FIG. 2 illustrates a schematic diagram of an example MRI system 210. MR images may be acquired by MRI system 210. In magnetic resonance imaging (MRI), a subject is placed in a magnet. When the subject is in the magnetic field generated by the magnet, magnetic moments of nuclei, such as protons, attempt to align with the magnetic field but precess about the magnetic field in a random order at the nuclei's Larmor frequency. The magnetic field of the magnet is referred to as B0 and extends in the longitudinal or z direction. In acquiring an MRI image, a magnetic field (referred to as an excitation field B1), which is in the x-y plane and near the Larmor frequency, is generated by a radio-frequency (RF) coil and may be used to rotate, or “tip,” the net magnetic moment Mz of the nuclei from the z direction to the transverse or x-y plane. A signal, which is referred to as an MR signal, is emitted by the nuclei, after the excitation signal B1 is terminated. To use the MR signals to generate an image of a subject, magnetic field gradient pulses (Gx, Gy, and Gz) are used. The gradient pulses are used to scan through the k-space, the space of spatial frequencies or inverse of distances. A Fourier relationship exists between the acquired MR signals and an image of the subject, and therefore the image of the subject may be derived by reconstructing the MR signals.

In the example embodiment, MRI system 210 includes a workstation 212 having a display 214 and a keyboard 216. Workstation 212 includes a processor 218, such as a commercially available programmable machine running a commercially available operating system. Workstation 212 provides an operator interface that allows scan prescriptions to be entered into MRI system 210. Workstation 212 is coupled to a pulse sequence server 220, a data acquisition server 222, a data processing server 224, and a data store server 226. Workstation 212 and each server 220, 222, 224, and 226 communicate with each other.

In the example embodiment, pulse sequence server 220 responds to instructions downloaded from workstation 212 to operate a gradient system 228 and a radiofrequency (“RF”) system 230. The instructions are used to produce gradient and RF waveforms in MR pulse sequences. An RF coil 238 and a gradient coil assembly 232 are used to perform the prescribed MR pulse sequence. RF coil 238 is shown as a whole body RF coil. RF coil 238 may also be a local coil that may be placed in proximity to the anatomy to be imaged, or a coil array that includes a plurality of coils.

In the example embodiment, gradient waveforms used to perform the prescribed scan are produced and applied to gradient system 228, which excites gradient coils in gradient coil assembly 232 to produce the magnetic field gradients Gx, Gy, and Gz used for position-encoding MR signals. Gradient coil assembly 232 forms part of a magnet assembly 234 that also includes a polarizing magnet 236 and RF coil 238.

In the example embodiment, RF system 230 includes an RF transmitter for producing RF pulses used in MR pulse sequences. The RF transmitter is responsive to the scan prescription and direction from pulse sequence server 220 to produce RF pulses of a desired frequency, phase, and pulse amplitude waveform. The generated RF pulses may be applied to RF coil 238 by RF system 230. Responsive MR signals detected by RF coil 238 are received by RF system 230, amplified, demodulated, filtered, and digitized under direction of commands produced by pulse sequence server 220. In the example embodiment, physiological acquisition controller 240 transmits the RF coil 238 pulse to the pulse sequence server 220. RF coil 238 is described as a transmitter and receiver coil such that RF coil 238 transmits RF pulses and detects MR signals. In one embodiment, MRI system 210 may include a transmitter RF coil that transmits RF pulses and a separate receiver coil that detects MR signals. A transmission channel of RF system 230 may be connected to a RF transmission coil and a receiver channel may be connected to a separate RF receiver coil. Often, the transmission channel is connected to the whole body RF coil 238 and each receiver section is connected to a separate local RF coil.

In the example embodiment, the pulse sequence server 220 and RF coil 238 are in communication with scan room interface 242. Scan room interface 242 allows for the interactive display of RF pulse positioning, pulse sequencing, etc. The example embodiment further includes patient positioning system 244, which allows for the repositioning of the patient within the magnet assembly 234 for better imaging.

In the example embodiment, RF system 230 also includes one or more RF receiver channels. Each RF receiver channel includes an RF amplifier that amplifies the MR signal received by RF coil 238 to which the channel is connected, and a detector that detects and digitizes the I and Q quadrature components of the received MR signal. The magnitude of the received MR signal may then be determined as the square root of the sum of the squares of the I and Q components as in Eq. (1) below:

$$M = \sqrt{{I}^{2} + {Q}^{2}} ; \qquad ( 1 )$$

and the phase of the received MR signal may also be determined as in Eq. (2) below:

$$φ = {tan}^{- 1} ( \frac{Q}{I} ) . \qquad ( 2 )$$

In the example embodiment, the digitized MR signal samples produced by RF system 30 are received by data acquisition server 222. Data acquisition server 222 may operate in response to instructions downloaded from workstation 212 to receive real-time MR data and provide buffer storage such that no data is lost by data overrun. In some scans, data acquisition server 222 does little more than pass the acquired MR data to data processing server 224. In scans that need information derived from acquired MR data to control further performance of the scan, however, data acquisition server 222 is programmed to produce the needed information and convey it to pulse sequence server 220. For example, during prescans, MR data is acquired and used to calibrate the pulse sequence performed by pulse sequence server 220. Also, navigator signals may be acquired during a scan and used to adjust the operating parameters of RF system 230 or gradient system 228, or to control the view order in which k-space is sampled.

In the example embodiment, data processing server 224 receives MR data from data acquisition server 222 and processes it in accordance with instructions downloaded from workstation 212. Such processing may include, for example, Fourier transformation of raw k-space MR data to produce two or three-dimensional images, the application of filters to a reconstructed image, the performance of a back projection image reconstruction of acquired MR data, the generation of functional MR images, and the calculation of motion or flow images.

In the example embodiment, images reconstructed by data processing server 224 are conveyed back to, and stored at, workstation 212. In some embodiments, real-time images are stored in a database memory cache (not shown in FIG. 2), from which they may be output to operator display 214 or a display 246 that is located near magnet assembly 234 for use by attending physicians. Batch mode images or selected real time images may be stored in a host database on disc storage 248 or on a cloud. When such images have been reconstructed and transferred to storage, data processing server 224 notifies data store server 226. Workstation 212 may be used by an operator to archive the images, produce films, or send the images via a network to other facilities.

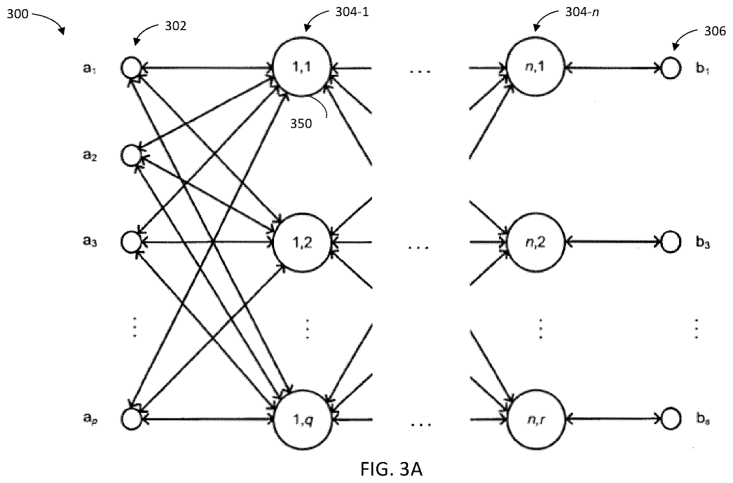

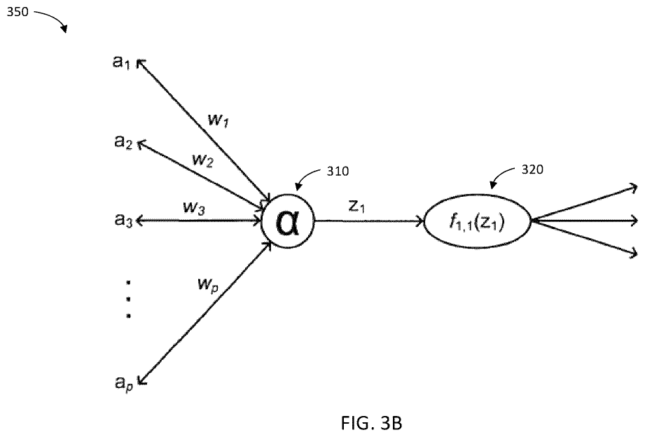

FIG. 3A depicts an example artificial neural network model 304. Denoising machine learning model 700 and/or denoising diffusion probabilistic model 600 may be implemented with one or more neural network models 304. The example neural network model 304 includes layers of neurons 302, 304-1 to 304-n, and 306, including an input layer 302, one or more hidden layers 304-1 through 304-n, and an output layer 306. Each layer may include any number of neurons, i.e., q, r, and n in FIG. 3A may be any positive integer. It should be understood that neural networks of a different structure and configuration from that depicted in FIG. 3A may be used to achieve the methods and systems described herein.

In the example embodiment, the input layer 302 may receive different input data. For example, the input layer 302 includes a first input a1 representing training images, a second input a2 representing patterns identified in the training images, a third input a3 representing edges of the training images, and so on. The input layer 302 may include thousands or more inputs. In some embodiments, the number of elements used by the neural network model 304 changes during the training process, and some neurons are bypassed or ignored if, for example, during execution of the neural network, they are determined to be of less relevance.

In the example embodiment, each neuron in hidden layer(s) 304-1 through 304-n processes one or more inputs from the input layer 302, and/or one or more outputs from neurons in one of the previous hidden layers, to generate a decision or output. The output layer 306 includes one or more outputs each indicating a label, confidence factor, weight describing the inputs, and/or an output image. In some embodiments, however, outputs of the neural network model 304 are obtained from a hidden layer 304-1 through 304-n in addition to, or in place of, output(s) from the output layer(s) 306.

In the example embodiment, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In the example embodiment, the layers are not clearly delineated in terms of the functionality they perform. For example, two or more of hidden layers 304-1 through 304-n may share decisions relating to labeling, with no single layer making an independent decision as to labeling.

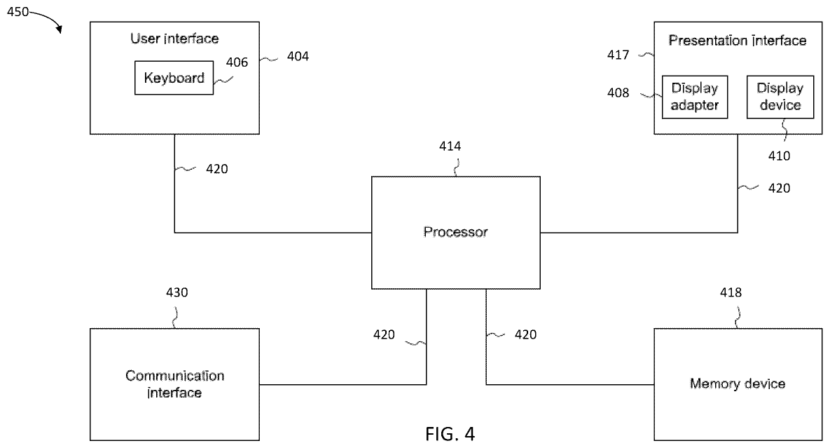

FIG. 3B depicts an example embodiment of a neuron 350 that corresponds to the neuron labeled as “1,1” in hidden layer 304-1 of FIG. 4A, according to one embodiment. Each of the inputs to the neuron 350 (e.g., the inputs in the input layer 302 in FIG. 3A) is weighted such that input a1 through ap corresponds to weights w1 through wp as determined during the training process of the neural network model 304.

In the example embodiment, some inputs lack an explicit weight, or have a weight below a threshold. The weights are applied to a function a (labeled by a reference numeral 310), which may be a summation and may produce a value z1 which is input to a function 320, labeled as f1, 1(z1). The function 320 is any suitable linear or non-linear function. As depicted in FIG. 3B, the function 320 produces multiple outputs, which may be provided to neuron(s) of a subsequent layer, or used as an output of the neural network model 304. For example, the outputs may correspond to index values of a list of labels, or may be calculated values used as inputs to subsequent functions.

It should be appreciated that the structure and function of the neural network model 304 and the neuron 350 depicted are for illustration purposes only, and that other suitable configurations exist. For example, the output of any given neuron may depend not only on values determined by past neurons, but also on future neurons.

In the example embodiment, the neural network model 304 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 304 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs in the example embodiment may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing-either individually or in combination. The machine learning programs may also include natural language processing, semantic analysis, automatic reasoning, and/or machine learning.

Based upon these analyses, the neural network model 304 in the example embodiment may learn how to identify characteristics and patterns that may then be applied to analyzing image data, model data, and/or other data. For example, the model 304 may learn to identify features in a series of data points.

FIG. 4 is a block diagram of an example user computing device 450. Systems and methods described herein may be at least partially implemented with one or more computing devices 450. Moreover, the one or more computing devices in the example embodiment may be image-processing computing devices. In the example embodiment, computing device 450 includes a user interface 404 that receives at least one input from a user. User interface 404 may include a keyboard 406 that enables the user to input pertinent information. User interface 404 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 450 includes a presentation interface 417 that presents information, such as input events and/or validation results, to the user. Presentation interface 417 may also include a display adapter 408 that is coupled to at least one display device 410. More specifically, in the example embodiment, display device 410 may be a visual display device, such as a cathode ray tube (CRT), a liquid crystal display (LCD), a light-emitting diode (LED) display, and/or an “electronic ink” display. Alternatively, presentation interface 417 may include an audio output device (e.g., an audio adapter and/or a speaker) and/or a printer.

In the example embodiment, computing device 450 also includes a processor 414 and a memory device 418. Processor 414 is coupled to user interface 404, presentation interface 417, and memory device 418 via a system bus 420. In the example embodiment, processor 414 communicates with the user, such as by prompting the user via presentation interface 417 and/or by receiving user inputs via user interface 404. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the example embodiment, memory device 418 includes one or more devices that enable information, such as executable instructions and/or other data, to be stored and retrieved. Moreover, memory device 418 includes one or more computer-readable media, such as, without limitation, dynamic random access memory (DRAM), static random access memory (SRAM), a solid state disk, and/or a hard disk. In the example embodiment, memory device 418 stores, without limitation, application source code, application object code, configuration data, additional input events, application states, assertion statements, validation results, and/or any other type of data. Computing device 250, in the example embodiment, may also include a communication interface 430 that is coupled to processor 414 via system bus 420. Moreover, communication interface 430 is communicatively coupled to data acquisition devices.

In the example embodiment, processor 414 may be programmed by encoding an operation using one or more executable instructions and providing the executable instructions in memory device 418. In the example embodiment, processor 414 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

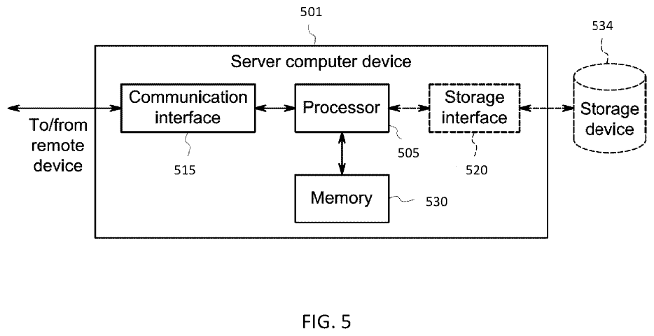

FIG. 5 illustrates an example configuration of a server computer device 501. Systems and methods described herein may be at least partially implemented with one or more server computer devices 501. Server computer device 501 also includes a processor 505 for executing instructions. Instructions may be stored in a memory area 530, for example. Processor 505 may include one or more processing units (e.g., in a multi-core configuration).

In the example embodiment, processor 505 is operatively coupled to a communication interface 515 such that server computer device 501 is capable of communicating with a remote device or another server computer device 501. For example, communication interface 515 may receive data from workstation 12, via the Internet.

In the example embodiment, processor 505 may also be operatively coupled to a storage device 534. Storage device 534 is any computer-operated hardware suitable for storing and/or retrieving data, such as, but not limited to, wavelength changes, temperatures, and strain. In some embodiments, storage device 534 is integrated in server computer device 501. For example, server computer device 501 may include one or more hard disk drives as storage device 534. In other embodiments, storage device 534 is external to server computer device 501 and may be accessed by a plurality of server computer devices 501. For example, storage device 534 may include multiple storage units such as hard disks and/or solid state disks in a redundant array of inexpensive disks (RAID) configuration. Storage device 534 may include a storage area network (SAN) and/or a network attached storage (NAS) system.

In the example embodiment, processor 505 is operatively coupled to storage device 534 via a storage interface 520. Storage interface 520 is any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

### EXAMPLES

### Example 1. TagGen: Diffusion-Based Generative Model for Cardiac MR Tagging Super Resolution

TagGen refers to an example method for cardiac MR tagging to increase spatial resolution using a diffusion-based generative model. The example embodiment, as described herein, develops a cascaded diffusion-based super-resolution model (as depicted in FIG. 6A) for low-resolution MR tagging acquisitions, which is integrated with parallel imaging to achieve highly accelerated MR tagging while enhancing the tag grid quality of low-resolution images.

In the example embodiment, TagGen includes a diffusion-based conditional generative model that uses low resolution (LR) MR tagging images as guidance to generate corresponding high-resolution (HR) tagging images. For the example embodiment, the model was developed on 50 patients with long-axis view high-resolution tagging acquisitions. Furthermore, during training of the model described in the example embodiment, LR tagging images were retrospectively synthesized by employing an undersampling rate (R) of 3.3 with truncated outer phase encoding lines. Furthermore, during inference, in the example embodiment, the performance of TagGen was evaluated and compared with REGAIN, a generative adversarial network (GAN)-based super-resolution model that was previously applied to MR tagging. In addition, in the example embodiment, data was prospectively acquired from six subjects with three heartbeats per slice using 10-fold acceleration achieved by combining low-resolution R=3.3 with GRAPPA-3.

In the example embodiment, for synthetic data (R=3.3), TagGen outperformed REGAIN in terms of nRMSE, PSNR, and SSIM (P<0.05 for all). For prospectively 10-fold accelerated data, TagGen provided better tag grid quality, SNR, and overall image quality than REGAIN as blinded scored by two radiologists (P<0.05 for all).

The example embodiment disclosed herein presents the development of a diffusion-based generative SR model for MR tagging images and its demonstrated potential to integrate with parallel imaging to reconstruct highly accelerated cine MR tagging images acquired in three heartbeats with enhanced tag grid quality.

### 1. Introduction

Cardiovascular disease is the leading cause of morbidity and mortality. Cardiac magnetic resonance (CMR)-based myocardial deformation analysis has growing importance for many types of heart diseases assessment. Cardiac MR tagging is recognized as the gold standard for assessing regional myocardial deformation because of its direct visualization of myocardial displacement using physical markers. However, strain-dedicated approaches, such as harmonic phase (HARP), displacement encoding with stimulated echoes (DENSE), and strain encoding (SENC), prolongs the scan times.

To incorporate the reproducible MR tagging method into an efficient clinical workflow, multiple approaches have been developed for MRI acceleration, such as parallel imaging, model-based methods and deep learning-based algorithms. While accelerated acquisition enables reduced scan time, high acceleration rates may affect signal-to-noise ratio (SNR) and/or the tag grids. MR tagging, which uses low flip angles to mitigate severe tagline decay in later cardiac phases, do not inherently provide a high SNR. The relatively lower SNR and sensitivity of tagged signals in MR tagging limit its compatibility with high acceleration rates.

MR tagging commonly uses spatial modulation of magnetization (SPAMM) to modulate the underlying image, producing an array of spectral peaks in the Fourier domain. The lowest harmonic frequency in a certain tag direction, located near the k-space center, contains most of the tagging information. Therefore, acquiring low-resolution MR tagging images is suitable as an alternative for accelerating MR tagging. In addition, low-resolution acquisition brings the benefits of improved SNR, which may be leveraged to combine with parallel imaging and compromise the SNR loss induced by parallel imaging, enabling higher SNR with highly accelerated tagging acquisition. However, low-resolution acquisition necessitates super-resolution (SR) as a subsequent post-processing and requires the SR algorithms to accurately restore high-resolution (HR) images with high quality taglines. Deep learning-based SR offers a new opportunity and has been shown to outperform traditional interpolation-based SR methods in medical imaging, due to its ability to extract prior knowledge. Recent advancements in deep generative models have shown promise for SR tasks in cardiac MR imaging. However, Generative Adversarial Network (GAN) often suffers from unstable training and mode collapse. In contrast, diffusion models have demonstrated the capability of training stability and high-quality sample generation across various vision tasks. By using the low-resolution as the conditional input, the diffusion model generates a corresponding high-resolution image from pure noise, guided by the conditional low-resolution images.

The example embodiment describes a diffusion-based conditional generative model that uses LR MR tagging images as guidance to generate corresponding high-resolution MR tagging images. In some embodiments, TagGen may be further integrated with Generalized Autocalibrating Partially Parallel Acquisitions (GRAPPA) to reconstruct highly accelerated (10-fold) cine MR tagging images acquired in three heartbeats with enhanced tag grid quality.

### 2. Materials and Methods

2.1 Imaging data

### 2.1.1 Retrospective MR Tagging Acquisition

MR tagging images were collected from 50 heart disease patients without obvious artifacts, including 2400 images from 120 long-axis view slices, at University of Missouri-Columbia Hospital from August 2022 to June 2024 using a 1.5T MAGNETOM Aera® (Siemens Healthineers). The dataset was split at the subject-level with a ratio of 70:10:20 for training, validation and testing, resulting in 1,605 training, 260 validation, and 535 testing images. Patients underwent long-axis view MR tagging slices during repeated breath holds, using view sharing to enhance tagline quality in later cardiac phases. Imaging parameters of the gradient echo tagging sequence included: repetition time 4.2-5.5 msec; echo time 1.9-2.6 msec; flip angle 10-12°; tag spacing 8 mm; resolution 1.5 mm×1.5 mm; matrix size 204×240-240×240; temporal frames 18-25.

### 2.1.2 Prospective MR Tagging Acquisition

For prospective validation of TagGen with 10-fold acceleration, 4 patients and 2 volunteers were scanned with a 30% central phase-encoding k-space (R=3.3) (see FIG. 6D) and GRAPPA-3 (ACS=24, where ACS is autocalibration signal lines), eliminating temporal blurring without the use of view sharing. Each acquisition was performed over three heartbeats per slice. Volunteer scans used a 1.5T MAGNETOM Aera® and patient scans used a 3T Vida (Siemens Healthineers), using similar protocols as in retrospective acquisitions.

2.2 Conditional Generation with Denoising Diffusion Probabilistic Models

The Denoising Diffusion Probabilistic Models (DDPM) (e.g., the example denoising diffusion probabilistic model 600) include two processes as shown in FIG. 6A: the forward diffusion process q and reverse diffusion process p. As depicted in FIG. 6A, the forward diffusion process follows the Markov process to gradually add Gaussian to the HR tagging image y₀ step by step until the image converges to a pure Gaussian distribution y_{T}. The reverse process utilizes a U-Net model, trained to conditionally denoise the image to reconstruct HR tagging image [symbol] using the LR tagging image x as the guidance.

### 2.2.1 Forward Diffusion Process

The forward diffusion process, in the example embodiment, is designed to transform the HR tagging image y₀ into pure Gaussian noise by adding a small amount of noise iteratively over T iterations via the diffusion kernel (Eq. 1). Equation 2 provides the complete generation process.

$$q ( {y}_{t} \vert {y}_{t - 1} ) = N ( {y}_{t} \vert \sqrt{{α}_{t}} {y}_{t - 1} , ( 1 - {α}_{t} ) I ) , \qquad ( 1 )$$

$$q ( {y}_{1 : T} \vert {y}_{0} ) = {\prod }_{t = 1}^{T} q ( {y}_{t} \vert {y}_{t - 1} ) , \qquad ( 2 )$$

where at, 1≤t≤T is a variance schedule subject to 0<αₜ<1. T is set to 2000, and the added Gaussian noise to the HR image generated a sequence of noisy images with increasing noise level y∈[y₁, y₂, . . . , y_{T}].

### 2.2.2 Reverse Diffusion Process

The reverse diffusion process, in the example embodiment, is defined as a reverse Markov process in Eq. 3, which starts from Gaussian noise y_{T} and is gradually denoised to reconstruct HR tagging images [symbol] :

$${p}_{θ} ( {y}_{t - 1} \vert {y}_{t} , x ) = N ( {y}_{t - 1} \vert {μ}_{θ} ( x , {y}_{t} , {γ}_{t} ) , {σ}_{t}^{2} I ) , \qquad ( 3 )$$

where p_{θ}(yₜ₋₁|yₜ, x) is the posterior distribution to be learned, μ_{θ}(x, yₜ, γₜ) is the distribution mean,

$${γ}_{t} = {Σ}_{i = 1}^{t} {α}_{i} ,$$

distribution variance

$${σ}_{t}^{2}$$

is fixed to be 1−αₜ.

In the example embodiment, after parametrization of the mean of the distribution, each denoising step in the reverse process will be:

$${y}_{t - 1} ← \frac{1}{\sqrt{{α}_{t}}} [ {y}_{t} - \frac{1 - {α}_{t}}{\sqrt{1 - {γ}_{t}}} {f}_{θ} ( x , {y}_{t} , {γ}_{t} ) ] + \sqrt{1 - {α}_{t}} {ϵ}_{t} , \qquad ( 4 )$$

where ƒ_{θ}(x, yₜ, γₜ) is the denoising model, ∈ₜ is the predicted noise at step t with ∈ₜ~N(0, 1).

### 2.2.3 Network Architecture

In the example embodiment, the denoiser is achieved using a U-Net model. The input of the model starts with pure Gaussian noise and a LR tagging image, with the corresponding HR tagging image as the ground truth. The model will refine the noisy output using a U-Net model trained to predict the noise at various noise levels, with the loss function defined as the L1-loss between the predicted noise and the added noise. The training objective is defined as:

$${‖ {f}_{θ} ( x , \sqrt{γ} {y}_{0} + \sqrt{1 - γ} ϵ , γ ) - ϵ ‖}_{1}^{1} , \qquad ( 5 )$$

where ƒ_{θ} represents the denoising U-Net model, (x, y₀) is sampled from LR-HR paired training set, e is the added noise, drawn from ∈~N(0, 1), and γ is scalar parameters related to the variance scheduler, defined as

$${γ}_{t} = {\sum }_{i = 1}^{t} {α}_{i} .$$

By conditioning the generation process with the LR tagging image, the resulting HR image will be uniquely determined with the anatomy and tag line information consistent with the acquired LR tagging.

To improve the generation quality, the example embodiment employs cascaded strategies with TagGen to iteratively apply the trained model multiple times, as depicted in FIG. 6B. At each stage, the model refines the output from the previous stage. Between each cascade stage, we enforced k-space data consistency on the output of the previous stage [symbol] :

$$\text{?} = D ( {x}^{i} ) , \qquad ( 6 )$$

$${x}^{i} = \{ \begin{matrix}x , & i = 1 \\ {F}^{- 1} ( Ω ∘ F ( x ) + ( 1 - Ω ) ∘ F ( \text{?} ) ) , & i = 2 , … , N\end{matrix} \qquad ( 7 )$$

where N=3 is the cascade stage, x is the acquired LR image, xⁱ is the conditional input of the iₜₕ stage, D is the complete reverse diffusion process integrating the whole diffusion process over T iterations, [symbol] is the model output of the iₜₕ stage, F is the fast Fourier transform and F⁻¹ is the inverse fast Fourier transform, Ω is the acquired k-space location in the low-resolution acquisition.

### 2.3 Network Training

### 2.3.1 Synthetic Training Data

To synthesize low-resolution MRI data in k-space, the following processes were used to generate LR and HR pairs using the acquired HR MR tagging images (FIG. 6C). a) The center 30% of the phase-encoding lines of the HR images in k-space were used, while maintaining the data in the readout direction, and the outer k-space lines were zero-filled. b) After an inverse fast Fourier transform, the synthesized LR images were center cropped to a matrix size of 128×128. c) The same center cropping to 128×128 was also applied to the corresponding source HR images. Data augmentation on-the-fly was performed by random vertical flip and horizontal flip with a probability of 0.5, along with simulating low-resolution using 30-50% of k-space center lines. The input of the network was the synthetic LR images, and the ground truth were the corresponding HR images during model training.

The selection of 30% is based on the location of the lowest spectral peak in k-space, the inherent physical property of MR tagging. With the tagging line spacing of 8 mm and spatial resolution of 1.5 mm and utilizing MR tagging grid oriented at 45° and 135° angles, the harmonic peaks are positioned along the diagonal lines of k-space as indicated in FIG. 6C. Consequently, the relative location of the center of the harmonic peak in k-space along the phase encoding direction is determined using Eq. 8 as bellow:

$$\frac{{k}_{hpeak}}{{k}_{max}} \times \sqrt{2} = \frac{spatial resolution}{tag spacing} \times \sqrt{2} = \frac{1.5 mm}{8 mm} \times \sqrt{2} = 26.5 \% , \qquad ( 8 )$$

where kₕₚₑₐₖ is the spatial frequency of the harmonic peak, kₘₐₓ is the maximum spatial frequency of k-space. The low-resolution acquisition ratio is set at 30% to cover the majority of the harmonic peak regions.

### 2.3.2 Model Implementation

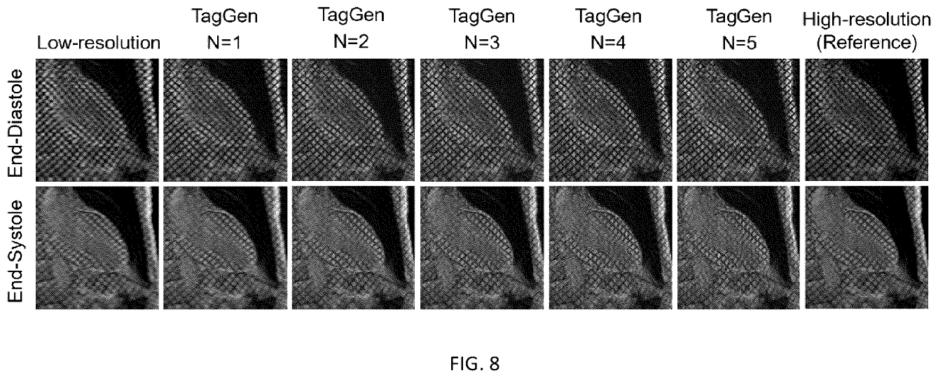

For the U-Net architecture, there were 2 input channels, representing the LR image and the noisy image, and 1 output channel, representing the generated less noisy HR images. The U-Net structure includes five levels, with the number of channels in each level being [64, 128, 256, 512, 512]. Each level contained two ResNet blocks with a dropout rate of 0.2, and an additional self-attention block was included at the bottleneck level. Detailed model architecture is depicted in FIG. 7. For the cascade length, two radiologists selected N=3 through visual assessment of N=1 to 5 of all prospective data (FIG. 8).

TagGen was implemented in Python with use of the PyTorch library on a 48 GB GPU (A6000; NVIDIA). The model is trained for 100,000 iterations with AdamW optimizer with a learning rate of 3e-5 and a batch size of 128. Source code is available online (https://github.com/MRImagingLab/TagGen).

### 2.4 Model Evaluation

### 2.4.1 Synthetic Testing Data Evaluation

For training, 80% of HR MR tagging images were used, and the remaining 20% (including 10 subjects) were used as the testing set. During inference, the maximum timestep was set to 2000 and DDPM sampling with linear variance schedule was used with full inference processes for each cascade stage. LR synthetic images were enhanced using TagGen and REGAIN. To compare these methods, normalized Root-Mean-Square-Error (nRMSE), Peak Signal-to-Noise Ratio (PSNR), and Structural Similarity Index (SSIM) were calculated, using original HR images as reference. Differences between the two methods were statistically tested using a paired t-test (P<0.05).

### 2.4.2 Prospectively Acquired Testing Data Evaluation

LR MR tagging images accelerated using GRAPPA-3 were acquired in three heartbeats, with matched HR images acquired in a subsequent breath-hold. Due to potential slice position mismatch, HR images were used for qualitative comparison. After GRAPPA reconstructions, LR images were super-resolved by TagGen and REGAIN. Two radiologists scored the super-resolved images on a 1-5 scale (1 is the worst and 5 is the best), assessing tag grid quality, SNR, and overall image quality. Inter-observer agreement was analyzed using the correlation coefficient, and method differences were tested with the Wilcoxon signed rank test.

### 3 Results

3.1 Evaluation with Synthetic Low-Resolution MR Tagging Data

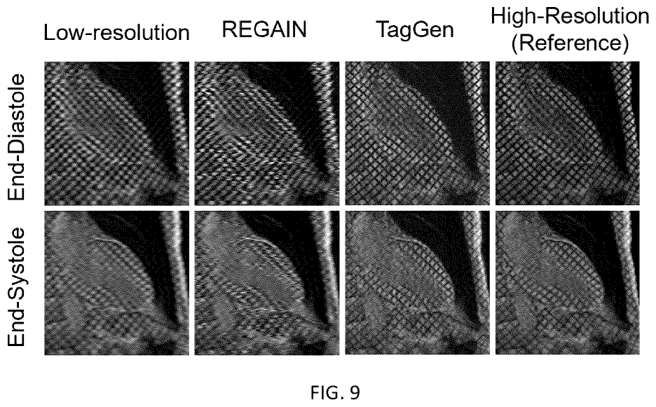

FIG. 9 shows example images from a patient with synthetic LR tagging using center 30% k-space lines, which were super-resolved using REGAIN and TagGen along with HR reference image. The two-chamber view images at end-diastole and end-systole are shown. Both REGAIN and TagGen improved image sharpness compared to the original LR images. TagGen demonstrated superior performance than REGAIN with sharper tag grids, better tag grid fidelity, and higher overall quality, as referenced by the HR images.

For the 10 patient subjects in the independent testing dataset, each subject had three long-axis view images, except for one patient who only had a 3-chamber view image, resulting in a total of 28 slices. For each slice, the evaluation metrics were compared image by image with the corresponding HR images serving as the reference and then averaged over the entire time series. Supporting Information Table 1 summarizes the nRMSE, PSNR, and SSIM results for the synthetic rate-3.3 dataset. TagGen demonstrated superior performance with higher SSIM, lower nRMSE and higher PSNR for all slices (P<0.05 for all metrics). Specifically, SSIM was 0.81±0.02 for TagGen compared to 0.77±0.03 for REGAIN; nRMSE was 6.08±1.01% for TagGen and 6.98±1.11% for REGAIN; and PSNR was 24.63±1.38 dB for TagGen and 23.46±1.40 dB for REGAIN.

TABLE 1

| Method | SSIM | nRMSE(%) | PSNR (db) |
|---|---|---|---|
| REGAIN | 0.77 ± 0.03 | 6.98 ± 1.11 | 23.46 ± 1.4 |
| TagGen | 0.81 ± 0.02 | 6.08 ± 1.01 | 24.63 ± 1.38 |

Table 1 shows quantitative comparisons of REGAIN and TagGen for super-resolving synthetic MR tagging images with rate R=3.3. The evaluation was performed on 28 slices from 10 independent subjects with HR tagging as the reference. TagGen demonstrated better performance on all three metrics compared to REGAIN, with lower nRMSE, higher PSNR, and higher SSIM.

3.2 Evaluation with Prospectively Acquired Low-Resolution MR Tagging Combined with GRAPPA-3

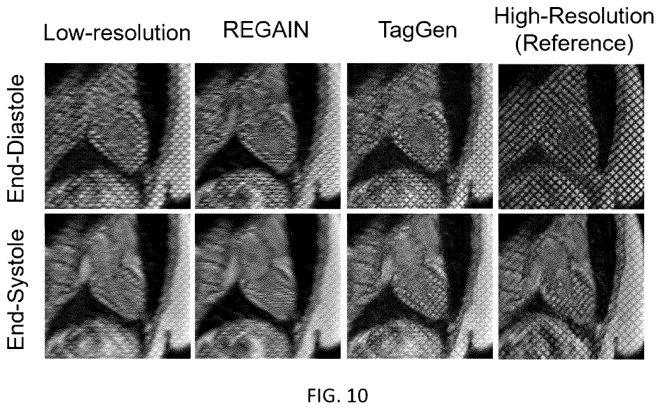

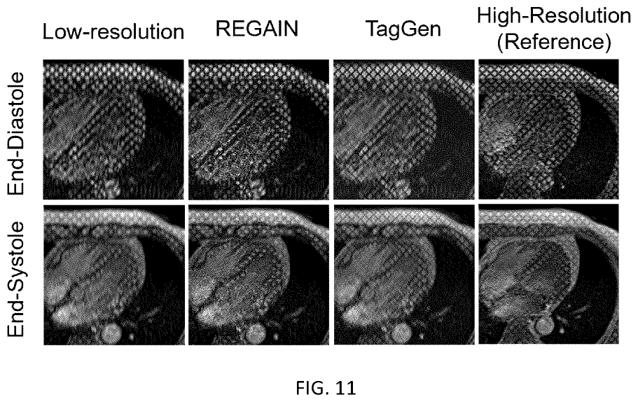

Example images showing prospective acquisition using a nominal 10-fold acceleration low-resolution acquisition with central 30% lines and rate-3 uniform undersampling from one volunteer at 1.5T are shown in FIG. 10. LR images were firstly reconstructed using GRAPPA followed by REGAIN and TagGen, with the high-resolution MR tagging images at the matched slice location in a different breath-hold as the reference. Example images of one patient example prospectively acquired from 3T scanner are shown in FIG. 11.

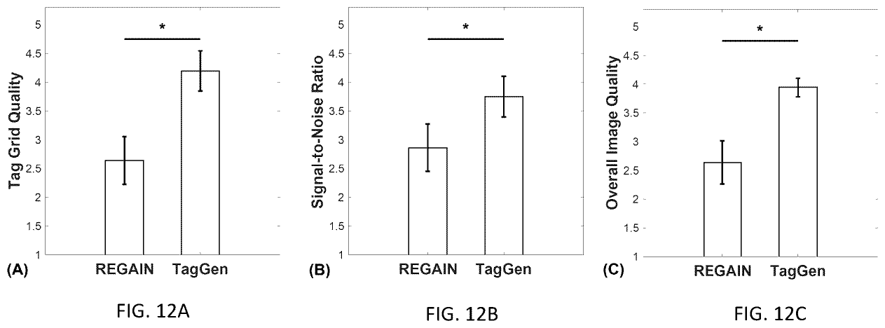

For the six prospectively acquired subjects, each subject had three long-axis view images, resulting in a total of 18 slices. Each slice was evaluated by two radiologists (FIGS. 12A-12C and Table 2). For REGAIN versus TagGen, the expert scoring results were 2.64±0.41 versus 4.19±0.35 (P<0.05) for tag grid quality; 2.86±0.41 versus 3.75±0.35 (P<0.05) for SNR; and 2.64±0.38 versus 3.94±0.16 (P<0.05) for overall image quality. There was good agreement between observer ratings for the three metrics of tag grid quality (r=0.68), SNR (r=0.66), and overall image quality (r=0.54).

TABLE 2

| | Tag Grid | | Overall Image |
|---|---|---|---|
| Method | Quality | SNR | Quality |
| REGAIN | 2.64 ± 0.41 | 2.86 ± 0.41 | 2.64 ± 0.38 |
| TagGen | 4.19 ± 0.35 | 3.75 ± 0.35 | 3.94 ± 0.16 |

Table 2 shows quantitative radiologist score comparisons of REGAIN and TagGen for super-resolving prospective MR tagging images with central 30% k-space and GRAPPA-3. The evaluation was performed on 18 slices from 4 patients and 2 volunteers. TagGen demonstrated better performance on all three metrics compared to REGAIN, with higher tag grid quality, signal-to-noise ratio, and overall image quality.

### Discussion

In this study, we developed a cascaded diffusion-based generative SR model that generates HR tagging images with recovered tagging grids and enhanced image resolution. Furthermore, we combined LR-based 3.3-fold acceleration and GRAPPA-based 3-fold acceleration and demonstrated the feasibility of TagGen to reconstruct the highly accelerated MR tagging images acquired in three heartbeats with high SNR, using high-SNR LR images as the condition to generate HR images, as justified in Appendix S1 (after this section of Discussion).

Achieving high acceleration in MR tagging is challenging due to the use of SPAMM preparation and T1-recovery induced tagline decay in late cardiac phases. Previous studies have explored reconstruction techniques, achieving high acceleration rates; however, using parallel imaging methods alone is challenging to achieve acceleration rates higher than 3 in clinical settings. Low-resolution acquisition is well-suited for MR tagging because of its intrinsic physics property of the location of harmonic peak and that it contains most of the tag line information. In addition, the inherently SNR advantages of low-resolution acquisition may be leveraged to combine with parallel imaging and compromise the SNR loss induced by uniform undersampling, resulting in higher SNR for highly accelerated tagging acquisitions. Therefore, we designed the acquisition protocol that combines GRAPPA (R=3) with low-resolution acquisition (R=3.3) for grid MR tagging, achieving nominal 10-fold acceleration rate.

GAN-based models have been employed for super-resolution tasks in cardiac MRI, but diffusion-based generation models have shown superior abilities in generating high-quality images (24). This makes them particularly suitable for the relatively challenging tag grid patterns, which are more prevalent in MR tagging protocols compared to tag line-based methods. REGAIN, a GAN-based super-resolution model designed for cardiac cine MRI, has been validated to be able to generalize to tag line-based MR tagging super-resolution with REGAIN-based 2-fold and CS-based 6-fold acceleration. For REGAIN, two separate MR tagging scans with tag line encoding are necessary to capture cardiac motion in the two directions. While REGAIN has been successful in enhancing the resolution of MR tagging lines, it is unclear if it may be used to recover the tag grid patterns. In our experiments, although REGAIN provides good sharpness, it is challenging to recover high quality tag grid patterns. The cascaded models enhance the image generation capabilities of TagGen. Both single and a cascade of three generative model shows more effectiveness for MR tag grid pattern generations than REGAIN, as illustrated in FIG. 9. However, there are no significant improvements in our experiments using a cascade of more than three diffusion generative models, as depicted in FIG. 8.

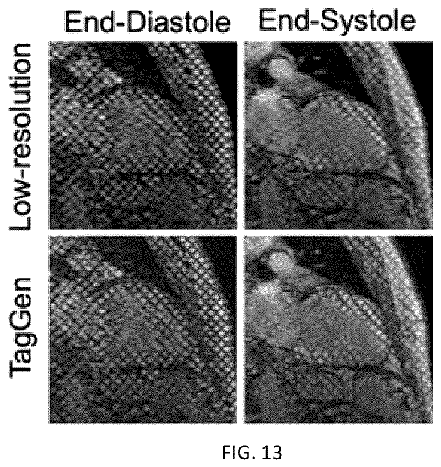

The example embodiment is trained on 1.5T dataset with view sharing, but the testing dataset includes both 1.5T and 3T, demonstrating that TagGen has good generalization ability to multiple field strengths. However, to train and validate the model more effectively and optimize parameters, a larger dataset from both 1.5T and 3T scanners may be used. The example embodiment focuses on long-axis view MR tagging as an example for illustration purposes only, and may incorporate short-axis view images. While the current model described in the example embodiment demonstrates generalization capabilities (as depicted in FIG. 13 and Table 3 below), the model may be further improved by increasing the size and diversity of the dataset to include a greater variety of acceleration rates, spatial resolutions and tagline spacings. The super-resolution model could also be enhanced by controlling noise and artifacts, incorporating patch-based generation, and synthesizing 3D isotropic MRI, as explored in GAN-based models. DDPM with full inference processes achieved high image quality, and acceleration approaches may be used to address its relatively slow inference. While we quantitatively evaluate our model with synthetic testing datasets and radiologist scoring for prospectively acquired data, MR tagging may be assessed by analyzing motion estimation and strain analysis. Deep learning-based motion tracking has been applied for the analysis of myocardial deformation. Physical features in MR tagging will provide intramyocardial features for deep motion tracking. The rapid MR tagging may be combined with automatic motion tracking.

TABLE 3

| | Tag Grid | | Overall Image |
|---|---|---|---|
| Method | Quality | SNR | Quality |
| 1.5T | 4.25 ± 0.42 | 3.58 ± 0.38 | 4.00 ± 0.00 |
| 3T | 4.17 ± 0.33 | 3.83 ± 0.33 | 3.92 ± 0.19 |

Table 3 depicts radiologist scoring (mean±standard deviation) of model performance on 1.5T and 3T prospective test data in terms of tag grid quality, SNR and overall image quality. As related to the example embodiment, no significant differences were observed in model performance between the two field strengths.

### Conclusion

The example embodiment, including TagGen, a diffusion-based super-resolution model designed to recover tagging grids and enhance image quality, leverages the harmonic peak physical property. Incorporating a low-resolution tagging acquisition that integrates with parallel imaging, TagGen enables highly accelerated MR tagging while providing SNR loss compensation. We demonstrated the feasibility of highly accelerated tag grid-based MR tagging, achieving the acquisition of a single slice within three heartbeats with enhanced tag grids.

### Appendix S1:

Due to the low flip angle used for improving tagline quality in the gradient echo tagging sequence, parallel imaging methods induced SNR penalties from the g-factor and reduction factor, which results in unfavorable SNR of MR tagging for further motion estimation. Low-resolution acquisition may not only improve the imaging speed, but also provides relatively higher SNR at the same acceleration rates than parallel imaging.

The SNR advantage from 30% center line acquisition low-resolution is v3.3; GRAPPA-3 with SNR penalty at 1/(g×\sqrt{3}), where g is the geometry factor. Theoretically, the total SNR loss of the low-resolution and GRAPPA-3 acquisition is \sqrt{v3.3}/(g×\sqrt{3}). Therefore, this protocol will induce SNR penalty by ~g factor. Image augmentation with added noise may further mitigate the noise.

### Example 2. Conditional Diffusion-Generated Super-Resolution for Myocardial Perfusion MRI

Myocardial perfusion MRI is important for diagnosing coronary artery disease, but current clinical methods face challenges in balancing spatial resolution, temporal resolution, and slice coverage. Achieving broader slice coverage and higher temporal resolution is needed for accurately detecting abnormalities across different slice locations but remains difficult due to constraints in acquisition speed and heart rate variability. While techniques like parallel imaging and compressed sensing have significantly advanced perfusion imaging, they still suffer from noise amplification, residual artifacts, and potential temporal blurring due to the rapid transit of dynamic contrast versus the temporal constraints of the reconstruction.

The embodiments disclosed herein describe a conditional diffusion-based generative model for myocardial perfusion MRI super resolution, addressing the trade-offs between spatiotemporal resolution and slice coverage. We adapted Denoising Diffusion Probabilistic Models (DDPM) to enhance low-resolution perfusion images into high-resolution outputs without requiring temporal regularization. The forward diffusion process introduces Gaussian noise incrementally, while the reverse process employs a U-Net architecture to progressively denoise the images, conditioned on the low-resolution input image.

In the example embodiments, the model is trained and validated on a retrospective dataset of dynamic contrast-enhanced (DCE) perfusion MRI, including both stress and rest images from 47 patients with heart disease. Associated results, in the example embodiments, showed significant image quality improvements, with a 20% reduction in nRMSE, a 6% increase in PSNR, and a 3% boost in SSIM compared to the conventional zero-padding method (P<0.05 for all metrics using paired t-test) in retrospective study. For the 9 prospective subjects, we achieved a total nominal acceleration of 8.5-fold across 5-6 slices through a combination of low-resolution acquisition and GRAPPA. PerfGen outperformed the zero-padding method in sharpness (3.89±0.22 vs. 4.89±0.22) and overall image quality (3.83±0.35 vs. 4.89±0.22), as assessed by two experts in a blinded evaluation (P<0.05) in prospective study.

The systems and methods described herein in connection with the example embodiment demonstrate the capability of diffusion-based generative models in generating high-resolution myocardial perfusion MRI from conditional low-resolution images. This approach has shown the potentials to accelerate myocardial perfusion MRI while enhancing slice coverage and temporal resolution, offering a promising alternative to existing methods.

### 1. Introduction

Improving myocardial perfusion MRI is needed for assessing perfusion defects, requiring a balance between high spatial resolution, temporal fidelity, and slice coverage. Clinically, sufficient spatial resolution is necessary to detect subtle perfusion abnormalities but achieving enough spatial resolution (<3.0 mm) and extensive slice coverage is particularly challenging under high heart rate conditions. The need to capture more slices (≥3 slices) within a short acquisition window further complicates the ability to fully resolve both motion and perfusion dynamics.

Recent techniques such as parallel imaging and compressed sensing, using both Cartesian and non-Cartesian sampling, have made progress in accelerating acquisition and increasing resolution in myocardial perfusion MRI. However, there remains open questions regarding the trade-offs between spatial and temporal fidelity, motion correction, as well as the potential for residual artifacts. Moreover, these methods typically require the complete acquisition of the entire temporal series to apply temporal regularization and motion correction, which may hinder the ability to display real-time images during contrast inflow and washout.

Given the ongoing challenges, there remains a need for alternative strategies to increase imaging speed for high temporal resolution and expanded slice coverage while simultaneously maintaining spatiotemporal fidelity. Low-resolution acquisitions inherently allow for faster imaging and higher signal-to-noise ratio (SNR), which may be crucial for capturing rapid contrast changes and minimizing the effects of cardiac and respiratory motion. By leveraging super-resolution methods, these images may be enhanced to achieve higher spatial fidelity, offering a balance between imaging speed and diagnostic quality.

However, low-resolution (LR) perfusion may suffer from reduced spatial details and fidelity, as well as more server dark rim artifacts. These artifacts may interfere with accurate perfusion analysis and affect diagnostic outcomes. To address this, strategies may be developed to compensate for the loss of spatial resolution and mitigate artifacts. Recent advances in deep learning, particularly generative models, provide a promising way for enhancing the quality of LR images in cardiac MR imaging. However, Generative Adversarial Networks (GANs) are prone to experience unstable training and mode collapse issues. In contrast, diffusion models have proven to produce high-quality images with robust training stability and superior image quality. Additionally, diffusion generative models offer a robust mechanism for improving spatial resolution of myocardial perfusion MRI without relying on temporal regularization. Previous studies have investigated GAN-based generative models on cardiac MRI, but applying generative models to myocardial perfusion MRI has not been explored. By conditioning the diffusion model on low-resolution perfusion images, it is possible to enhance image detail while retaining the benefits of rapid acquisition, high temporal resolution and expanded slice coverage.

A conditional diffusion-based generative model is provided for myocardial perfusion MRI super resolution, termed PerfGen, that leverages existing clinical imaging protocols and data to generate myocardial perfusion images conditioned by low-resolution images. This study shows that diffusion generative models may be integrated with myocardial perfusion MRI to synthesize high-resolution perfusion images and demonstrated its feasibility to accelerate the acquisition. This model provides an alternative solution that balances spatial resolution, temporal fidelity, and slice coverage, offering a new way for efficient and high-quality myocardial perfusion MRI.

### 2 Materials and Methods

### 2.1 Data Acquisition and Preprocessing

All patients provided informed consent, and all studies were performed in accordance with protocols approved by our institutional review board.

### 2.1.1 Retrospective Myocardial Perfusion Data

Dynamic contrast-enhanced (DCE) perfusion data were collected from 47 heart disease patients using standard clinical MRI protocols at the University of Missouri-Columbia Hospital, in the example embodiment. The dataset was divided into an 80:20 split, with 38 patients for training and 9 patients for testing. Each subject had 3 short-axis slices (base, mid, and apex), with all temporal frames used, resulting in a total of 8040 images for training and 1830 images for testing. A mixed dataset with both rest and stress perfusion data were collected using gadolinium contrast for perfusion and Regadenoson for stress with free breathing acquisition. Prospective electrocardiogram triggering was used for all patients. Within the training group, 15 patients underwent rest perfusion only, and 23 underwent stress perfusion only. For the testing group, 3 subjects were assessed under rest conditions and 6 under stress. All testing data and most training data were acquired on a 1.5T MAGNETOM Aera, except for 4 subjects from the training group were imaged using a 3T MAGNETOM Vida (Siemens Healthineers).

Imaging parameters for the gradient echo perfusion sequence included a repetition time of 2.2-2.3 msec, echo time of 1.08 msec, flip angles between 12° and 15°, resolution of 2.3-2.4 mm×2.3-2.4 mm, 60-80 temporal measurements, and a GRAPPA acceleration rate of 2. We use chest and spine phased-array receiver coils (20-34 channels) with an acquisition matrix of 160×120-160, a temporal resolution of 138-184 ms per slice, a saturation pulse delay of 100-120 ms, and acquire 3 slices per RR interval.

### 2.1.2 Prospective Myocardial Perfusion Data

Nine DCE rest perfusion patient data were collected at University of Missouri-Columbia Hospital using a 3T MAGNETOM Vida (Siemens Healthineers), with 8 acquired using GRAPPA-3 and 1 using GRAPPA-2. Prospective electrocardiogram triggering was used for all patients. Five to six short-axis myocardial perfusion slices were acquired per RR interval during free breathing. Imaging parameters of the gradient echo perfusion sequence included a repetition time of 2.2-2.3 msec, echo time of 1.08 msec, flip angles between 12° and 15°, resolution of 2.3-2.4 mm×2.3-2.4 mm, 60 temporal measurements, and a GRAPPA acceleration rate of 2-3. Late gadolinium enhancement (LGE) imaging was used as a reference for validating the super-resolved perfusion defects, particularly in the presence of late enhanced regions. The acquisition matrix size is 160×48-62 following a 35%-36% low-resolution acceleration, with 16-22 actual phase encoding lines acquired using GRAPPA-3. The temporal resolution was 36.8-50.6 ms per slice, with an inversion time of 100 ms for the saturation pulse, resulting in a total acquisition time of 118.4-125.3 ms per slice. For the GRAPPA-2 data, the acquisition matrix size is 176×62 following a 35% low-resolution acceleration, with 32 actual phase encoding lines acquired using GRAPPA-2. The temporal solution was 73.6 ms per slice, resulting in a total acquisition time of 136.8 ms.

### 2.1.3 Low-Resolution Data Preparation

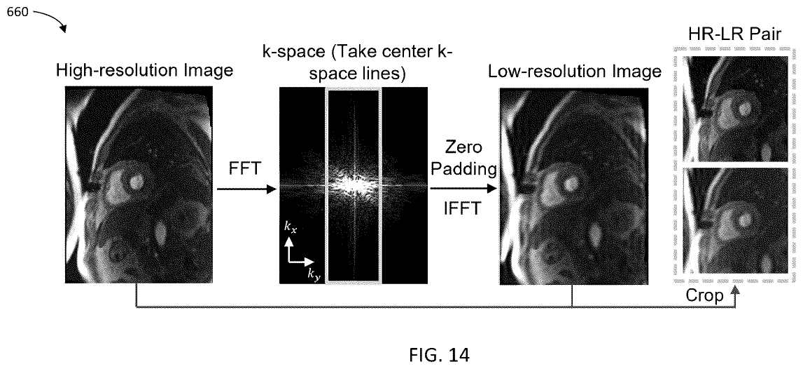

To simulate LR perfusion data from high-resolution (HR) perfusion images for model training, we used the following processes to generate LR and HR pairs (FIG. 14). Fast Fourier Transform was applied to the original HR magnitude image to convert to k-space domain for retrospective experiments. The center 30-50% of the phase-encoding lines were used, with the dynamic low-resolution ratio aiming for data augmentation. The outer k-space lines were zero-padded with the data in the readout maintained and converted back to the image domain using an inverse fast Fourier transform followed by taking the absolute value. Both the synthesized LR images and paired HR images were cropped to the same central 96×96 matrix size followed by the image normalization. The cropping was performed manually to position the heart within the cropped region. On-the-fly data augmentation included random vertical flip and horizontal flip, each applied with a probability of 50%. HR perfusion images served as the reference, and the LR synthetic images were enhanced using zero-padding and PerfGen. In the prospective study, the multi-coil complex-valued k-space data was truncated by setting the phase resolution to 35% in the sequence.

2.2 Conditional Generation with Denoising Diffusion Probabilistic Models

Given a dataset of LR-HR perfusion MRI pairs,

$${D = ( {x}_{i} , {y}_{i} \}}_{i = 1}^{N} ,$$

which are samples from an unknown conditional distribution of high-resolution myocardial perfusion MRI domain, a parametric approximation of p(y|x) was learned through a stochastic iterative refinement process that maps the source LR image x to target HR image [symbol] . We adapted the Denoising Diffusion Probabilistic Models (DDPM) and Image Super-Resolution via Iterative Refinement (SR3) to generate HR MR perfusion images from LR image through diffusion process.

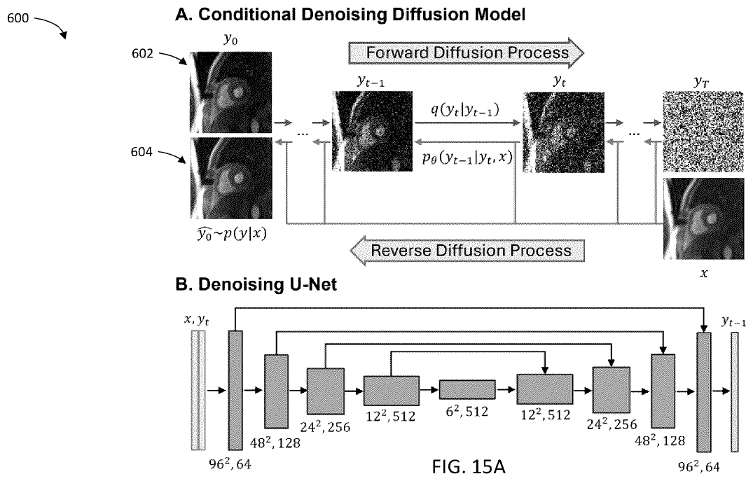

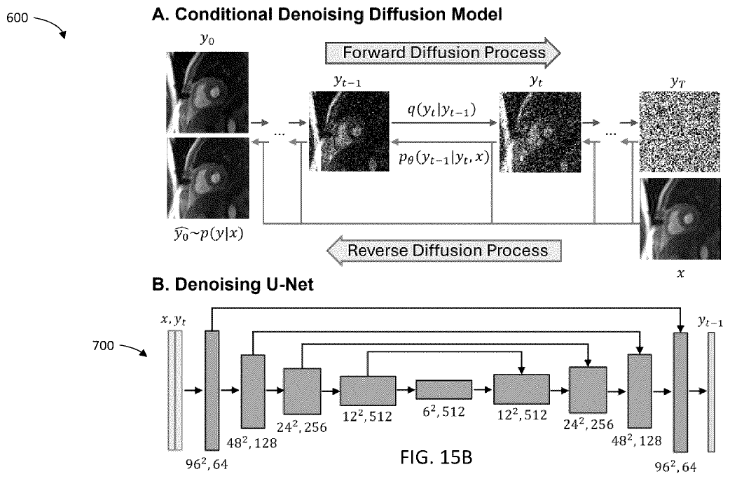

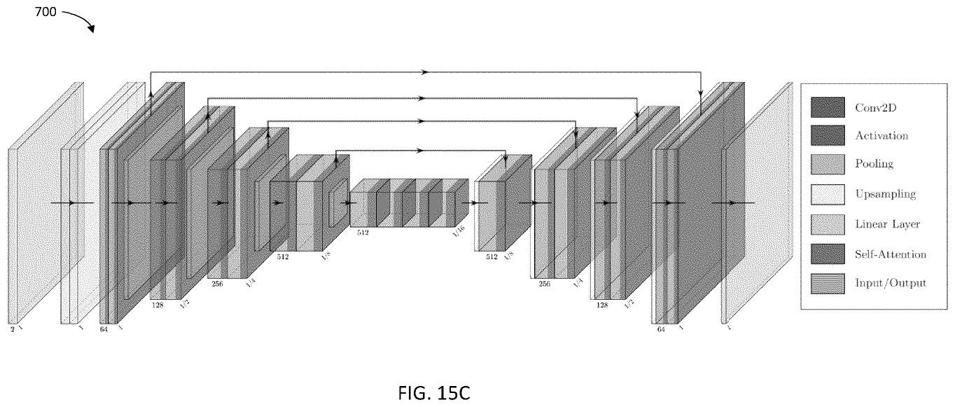

FIG. 15A provides an illustration of a conditional diffusion-based model to map Gaussian noise y_{T} to a HR image [symbol] , conditioned on the source LR image x. The forward diffusion process q follows the Markov process to gradually add Gaussian noise to the HR perfusion image y₀ step by step until the image converges to a pure Gaussian distribution y_{T}. The reverse process p utilizes a U-Net model, trained to conditionally denoise the image to reconstruct a HR perfusion image [symbol] using the LR perfusion image x as the guidance.

### 2.2.1 Forward Diffusion Process

The forward diffusion process gradually added Gaussian noise to the HR perfusion image y₀ over T iterations until the image converges to a Gaussian distribution via the diffusion kernel (equation 1). Equation 2 provides the complete generation process.

$$q ( {y}_{t} \vert {y}_{t - 1} ) = N ( {y}_{t} \vert \sqrt{{α}_{t}} {y}_{t - 1} , ( 1 - {α}_{t} ) I ) , \qquad ( 1 )$$

$$q ( {y}_{1 : T} \vert {y}_{0} ) = {\prod }_{t = 1}^{T} q ( {y}_{t} \vert {y}_{t - 1} ) , \qquad ( 2 )$$

where αₜ, 1≤t≤T is a variance schedule subject to 0<αₜ<1, I is the identity matrix. T is set to 2000, and the added Gaussian noise to the HR image generated a sequence of noisy images with increasing noise level y∈[y₁, y₂, . . . , y_{T}].

Specifically, q(yₜ) may be obtained directly from y₀ at any time step without iterations where

$${γ}_{t} = {\prod }_{i = 1}^{t} {α}_{t} .$$

$$q ( {y}_{t} \vert {y}_{0} ) = N ( {y}_{t} \vert \sqrt{{γ}_{t}} {y}_{0} , ( 1 - {γ}_{t} ) I ) . \qquad ( 3 )$$

### 2.2.2 Reverse Diffusion Process

The reverse diffusion process of the example embodiment is defined as a reverse Markov process, starting from Gaussian noise y_{T} and progressively denoised to reconstruct the HR perfusion images [symbol] :

$${p}_{θ} ( {y}_{0 : T} \vert x ) = P ( {y}_{t} ) {\prod }_{t = 1}^{T} {P}_{θ} ( {y}_{t - 1} \vert {y}_{t} , x ) , \qquad ( 4 )$$

$$p ( {y}_{T} ) = N ( {y}_{T} \vert 0 , I ) , \qquad ( 5 )$$

$${p}_{θ} ( {y}_{t - 1} \vert {y}_{t} , x ) = N ( {y}_{t - 1} \vert {μ}_{θ} ( x , {y}_{t} , {γ}_{t} ) , {σ}_{t}^{2} I ) \qquad ( 6 )$$

p₀(yₜ₋₁|yₜ, x) is the posterior distribution to be learned, distribution variance

$${σ}_{t}^{2}$$

is fixed to be 1−αₜ, distribution mean μ_{θ}(x, yₜ, γₜ) is reparametrized as:

$${μ}_{θ} ( x , {y}_{t} , {α}_{t} ) = \frac{1}{\sqrt{{α}_{t}}} [ {y}_{t} - \frac{1 - {α}_{t}}{\sqrt{1 - {γ}_{t}}} {f}_{θ} ( x , {y}_{t} , {γ}_{t} ) ] \qquad ( 7 )$$

where fƒ_{θ}(x, yₜ, γₜ) is the denoising model which takes the source LR perfusion image x and a noisy image yₜ to predict the noise E.

After the parametrization, each denoising step in the reverse process will be:

$${y}_{t - 1} ← \frac{1}{\sqrt{{α}_{t}}} [ {y}_{t} - \frac{1 - {α}_{t}}{\sqrt{1 - {γ}_{t}}} {f}_{θ} ( x , {y}_{t} , {γ}_{t} ) ] + \sqrt{1 - {α}_{t}} {ϵ}_{t} \qquad ( 8 )$$

where fƒ_{θ}(x, yₜ, γₜ) is the denoising model, ∈ₜ is the predicted noise at step t with ∈ₜ~N(0, 1).

### 2.2.3 Model Implementation

We adapted the SR3-DDPM model to super-resolve a 2D low-resolution MR perfusion image into a HR image. The denoiser is achieved using a U-Net model and the optimization that employs KL-divergence to maximize the likelihood of the generated HR images [symbol] and the ground truth HR image y₀. L2-loss between the noise predicted by the network and the amount of noise added was used, and the loss function was defined as:

$${E}_{( x , y )} {E}_{ϵ , γ} {‖ {f}_{θ} ( x , \sqrt{γ} {y}_{0} + \sqrt{1 - γ} ϵ , γ ) - ϵ ‖}_{2}^{2} \qquad ( 9 )$$

where ƒ_{θ} represents the denoising U-Net model, x is the LR image, y is the corresponding HR image, e is the added noise with ∈~N(0, 1), γ is a scalar parameter related to the variance scheduler with

$${γ}_{t} = {\sum }_{i = 1}^{t} {α}_{i} .$$

The model starts with pure Gaussian noise and a LR perfusion image, using the corresponding HR perfusion image as the ground truth. The model will iteratively refine the noisy output through a U-Net model trained to denoise at various noise levels and generate images with the desired HR perfusion data distribution. By using the LR perfusion MR image to condition the generation process, the SR image is specifically determined to maintain anatomical consistency similar to the original LR perfusion images.

In the U-Net architecture FIG. 15B, the input included two channels representing the LR image and the noisy image, and one output channel, representing the generated less noisy HR images. The LR and HR pairs in our synthesis pipeline maintained the same matrix size, and the conditioning LR image was used at the shallowest level of the U-Net by channel-wise concatenating with the noisy image. Both the LR image and noisy image at time step t were encoded through a convolutional layer followed by two linear layers for further encoding. The U-Net structure includes convolution, group normalization, Swish activation, residual connections and pooling layers. The U-Net structure includes five levels, with the number of channels in each level being [64, 128, 256, 512, 512]. Each level contained two ResNet blocks with a dropout rate of 0.2. At the bottleneck, an additional self-attention was applied after the convolution layers. The self-attention module employs convolutional layers to compute the query, key, and value representations for spatial attention. It is followed by another convolutional layer to refine the output and is interleaved with the original ResNet block at the bottleneck for enhanced feature representation. Detailed model architecture is depicted in FIG. 15C.

PerfGen was implemented using Python and PyTorch on two 48 GB NVIDIA A6000 GPUs. PerfGen had 92M trainable parameters. The model was trained for 50,000 iterations with AdamW optimizer with a learning rate of 3e-5 and a batch size of 128. During inference, we used DDPM sampling with full inference steps (T=2000).

### 2.3 Model Evaluation

To compare these methods using synthetic data, normalized Root-Mean-Square-Error (nRMSE), Peak Signal-to-Noise Ratio (PSNR), and Structural Similarity Index (SSIM) were calculated, using original HR images as reference. The metrics were evaluated within the 96×96 FOV, focusing specifically on the heart region. The nRMSE was calculated as:

$$nRMSE = \frac{1}{max ( I ) - min ( I )} \sqrt{\frac{1}{N} {\sum }_{i = 0}^{N - 1} {( {\tilde{I}}_{i} - {I}_{i} )}^{2}} \qquad ( 10 )$$

where Ĩ is either LR or SR images, I is the reference HR image, N is the total number of pixels, Ĩᵢ and Iᵢ are the pixel intensities at position i in the LR/SR and HR images, respectively. PSNR was calculated as:

$$PSNR = 10 \times {log}_{10} ( \frac{25 {5}^{2}}{\frac{1}{N} {\sum }_{i = 0}^{N - 1} {( {\tilde{I}}_{i} - {I}_{i} )}^{2}} ) \qquad ( 11 )$$

In the example embodiment, SSIM is calculated as:

$$SSIM = \frac{( 2 {μ}_{\tilde{I}} {μ}_{I} + {c}_{1} ) ( 2 {σ}_{\tilde{I} , I} + {c}_{2} )}{( {μ}_{\tilde{I}}^{2} + {μ}_{I}^{2} + {c}_{1} ) ( {σ}_{\tilde{I}}^{2} + {σ}_{I}^{2} + {c}_{2} )} \qquad ( 12 )$$

where μ_{Ĩ} and μ_{I} are the average and variance of Ĩ and I, σ_{Ĩ,I} is the covariance of Ĩ and I, and c₁ and c₂ are constants to prevent division by a near-zero denominator.

Differences between zero-padded images and PerfGen super-resolved images were statistically tested using a paired t-test (P<0.05). For prospective data, images super-resolved by PerfGen were qualitatively compared with LGE images at matched slice position to identify perfusion defects. One cardiologist and one radiologist scored prospectively acquired datasets on a 1-5 scale (1 being the worst and 5 being the best), assessing perfusion image sharpness and overall quality relative to clinical perfusion image standards. The inter-observer agreement was evaluated using the correlation coefficient, and differences between methods were assessed with the Wilcoxon signed-rank test.

### 3 Results

3.1 Model Validation with Synthetic Data

### 3.1.1 Qualitative Comparison

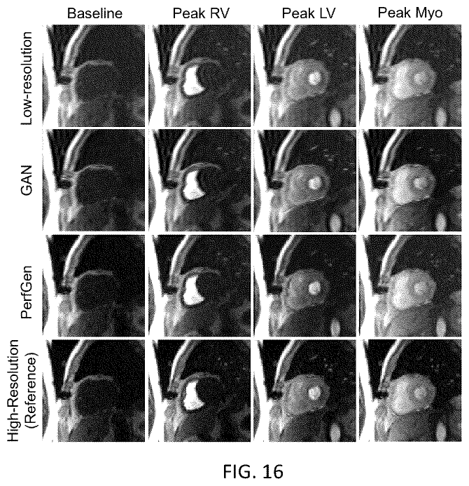

FIG. 16 compares the myocardial perfusion images across different phases of contrast enhancement during first-pass perfusion using synthetic test data. The PerfGen super-resolved images are compared to LR and HR reference images at baseline, peak right ventricle (RV), peak left ventricle (LV), and peak myocardium (Myo). The results show an improvement in the image resolution and contrast for the PerfGen super-resolved images, allowing for enhanced visualization of contrast perfusion through the myocardium. The enhanced detail provided by PerfGen aligned with the HR reference images.

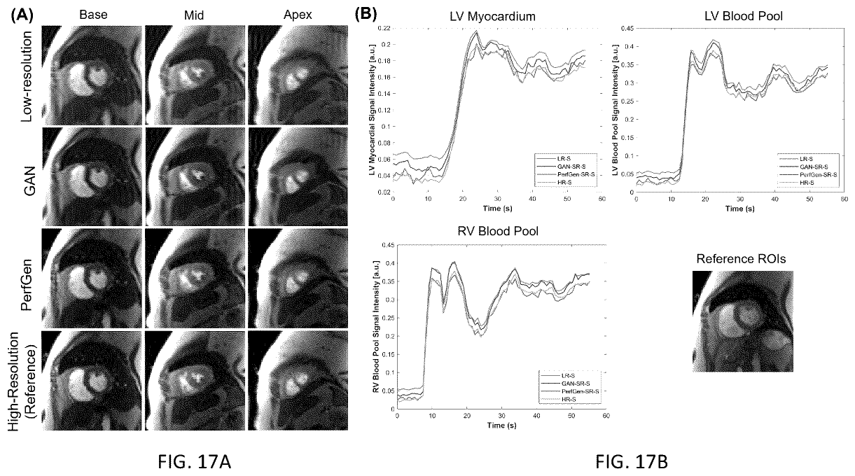

FIG. 17A further demonstrates the evaluation of the PerfGen by comparing myocardial perfusion images at the basal, midventricular, and apical slice locations. The PerfGen super-resolved images show enhanced resolution and structural details across all slice locations compared to the HR reference. FIG. 17B shows the signal-t plot illustrating the changes in the left-ventricular (LV) myocardial region, LV blood pool, and right-ventricular (RV) blood pool. The spatially super-resolved images demonstrate better alignment with the reference high-resolution spatial images compared to the acquired low-resolution spatial images.

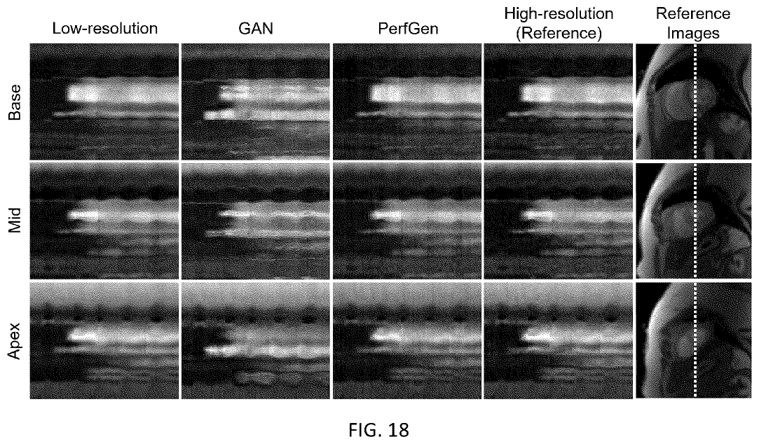

FIG. 18 presents example cross-sectional time-intensity profiles from the subject shown in FIGS. 17A & 17B, comparing low-resolution images, PerfGen super-resolved images, and reference high-resolution images. The PerfGen super-resolved method shows better temporal fidelity than the low-resolution images compared with the reference HR plots.

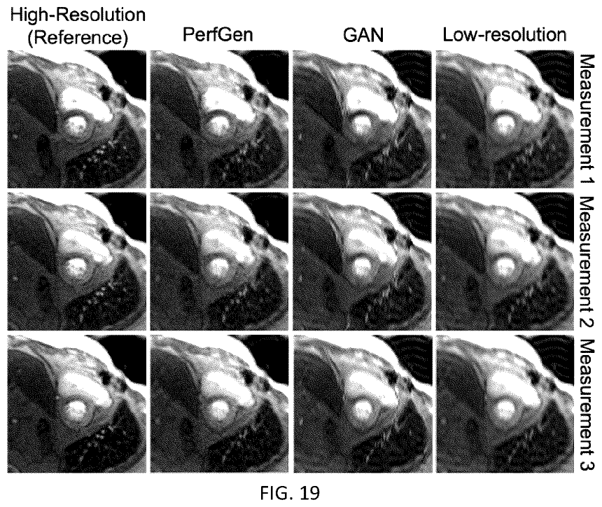

FIG. 19 shows the stress perfusion images of a patient with inducible myocardial ischemia. PerfGen demonstrates better alignment with HR reference images than LR images and GAN-based super-resolved images in terms of the overall image quality and the accurate perfusion defect detection.

### 3.1.2 Quantitative Comparison

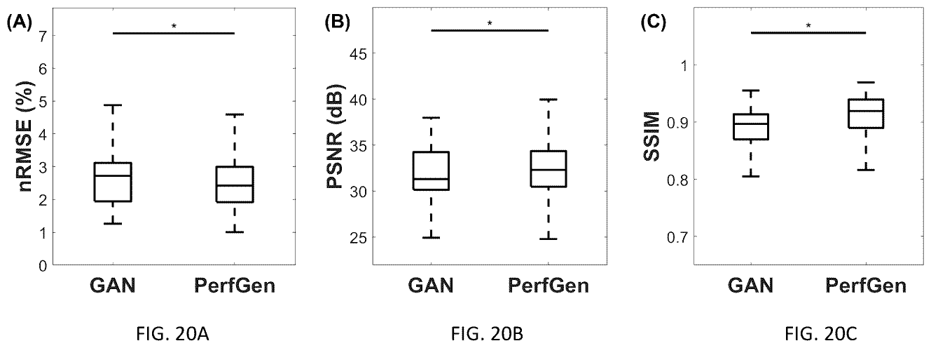

FIGS. 20A-20C present a quantitative comparison between zero-padded and PerfGen super-resolved myocardial perfusion images of nine testing datasets. The PerfGen method significantly outperformed the zero-padded approach across all evaluated metrics. Specifically, PerfGen achieved a 20% reduction in nRMSE (mean nRMSE: 0.032±0.01 for zero-padding vs. 0.026±0.008 for PerfGen, respectively), a 6% increase in PSNR (mean PSNR: 30.38±3.05 dB for zero-padding vs. 32.24±2.77 dB for PerfGen, respectively), and a 3% improvement in SSIM (mean SSIM: 0.86±0.051 for zero-padding vs. 0.89±0.037 for PerfGen, respectively). These improvements are statistically significant, as indicated by the asterisks in the figure, demonstrating the superior performance of PerfGen in enhancing image quality.

3.2. Model Validation with Prospectively Acquired Data

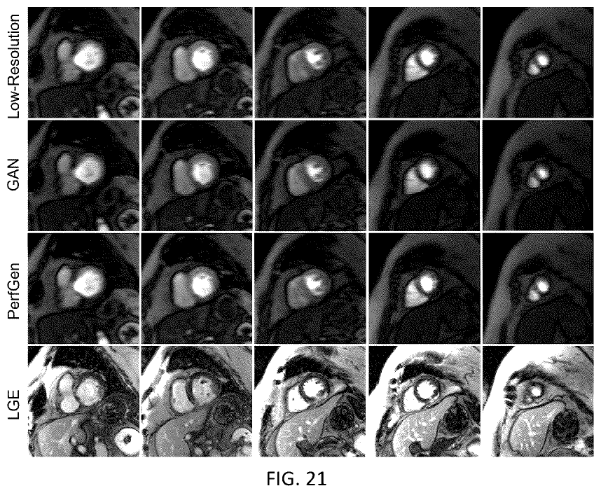

FIG. 21 shows a comparison of the super-resolved perfusion images with both LR perfusion images and LGE images. The super-resolved images show perfusion defects that closely match the defects observed in the LGE images at corresponding slice locations, providing proof-of-concept that PerfGen may potentially identify the super-resolve perfusion defects from LR images. Furthermore, the combination of a low-resolution acquisition with 35% phase lines and GRAPPA-2 allowed the acquisition of five slices, with a 2.86-fold improvement in temporal resolution compared to clinical routine settings, demonstrating the improved image quality with improved slice coverage.

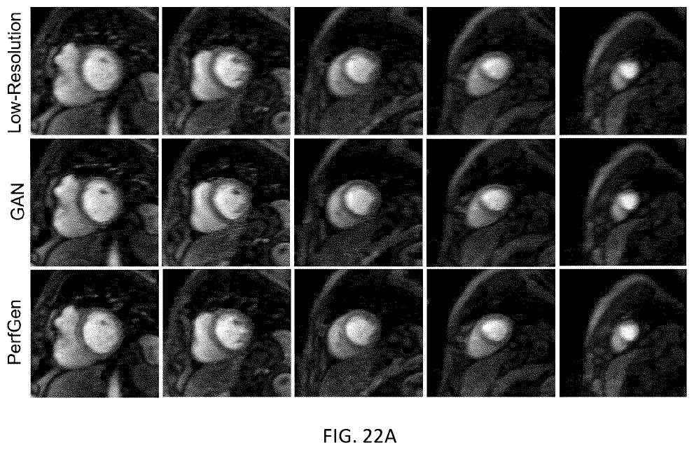

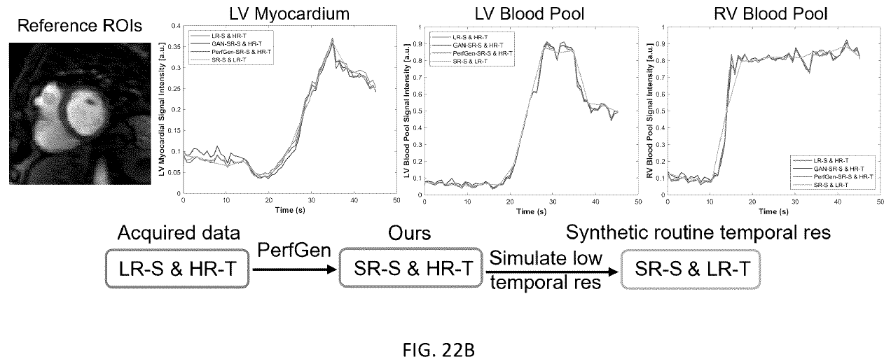

FIG. 22A provides evaluation of PerfGen in enhancing myocardial perfusion images across five different perfusion slices. Super-resolved images are compared with LR images using zero-padding for one prospectively acquired slice, showing improved contrast and image detail across various perfusion phases. The super-resolution method demonstrates improved visualization of image details that are not as obvious in the LR images acquired using GRAPPA-3 and 35% phase resolution. FIG. 22B shows the signal-time plots of the intensity changes over time in the LV myocardial region, LV blood pool and RV blood pool. The plots demonstrate that achieving a 4.3-fold increase in temporal resolution and five slices covered in myocardial perfusion MRI, compared to the clinically used GRAPPA-2 and three slices, improves the ability to capture sharp transitions in contrast during myocardial perfusion as compared against a synthetic low temporal resolution curve using rate-2 acceleration.

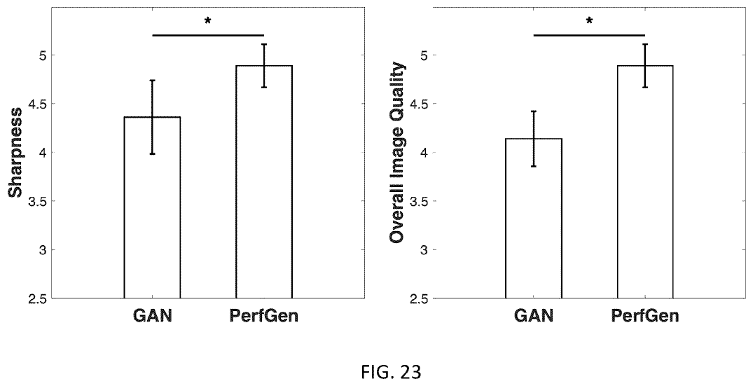

For the nine prospectively acquired subjects, all slices were evaluated by two experts in FIG. 23. For sharpness, the scores were 3.89±0.22 for zero-padding and 4.89±0.22 for PerfGen (P<0.05); for overall image quality, the scores were 3.83±0.35 for zero-padding and 4.89±0.22 for PerfGen (P<0.05). There was good agreement between observer ratings for sharpness (r=0.77) and overall image quality (r=0.57).

PerfGen not only improves spatial resolution but also enhance image features, such as perfusion defects, which align well with LGE reference images, providing proof of concept for demonstrating the potential of super-resolution techniques in diagnostic accuracy in myocardial perfusion imaging.

### 4 Discussion

With the growing interest for myocardial perfusion MRI in identifying myocardial ischemia, there is an increased need for high spatiotemporal resolution and expanded slice coverage to accurately monitor dynamic changes in blood flow and myocardial perfusion. This is challenged by the acquisition speed to capture rapid change and fine details without sacrificing the quality and accuracy necessary for effective diagnosis. Low-resolution is an alternative approach that inherently allowing for acceleration and higher SNR. However, the reduction in spatial and temporal details may degrade the image quality, influence the diagnosis accuracy and potentially impact the subsequent quantitative analysis.

The technical improvements of the example embodiment present that existing clinical perfusion MRI images may be effectively used to train a conditional diffusion generative model for super-resolution. A super-resolution pipeline is provided that utilizes low-resolution myocardial perfusion MRI as the guidance after initial reconstruction by GRAPPA, which is also potentially applicable to compressed sensing or unrolled network outputs, offering a complementary approach to the existing workflows. When combined with GRAPPA (factor 2-3) in prospective acquisitions, this method offers a nominal 5.7-8.5 folds acceleration, allowing for better slice coverage and improved temporal resolution. This approach not only accelerates acquisition but also mitigates the loss of contrast and detail typically associated with low-resolution imaging. In the example embodiment, the model was validated with an infarction patient with reference LGE images, with the perfusion defects showing consistent with the scar regions in LGE.

While diffusion generative models have demonstrated the training stability and high-quality image generation across various vision tasks, their application in generating myocardial perfusion MRI and integration with cardiac MRI have yet to be explored. In our study, we observed that the diffusion generative model generated perfusion images that are comparable to clinical routine GRAPPA-2 perfusion images, which demonstrates the potential of the generative model to improve diagnostic accuracy and clinical utility. This super-resolution approach offers several key advantages: (1) it effectively generates fine image details, outperforming the zero-padding method, (2) the combination of low-resolution acquisition and GRAPPA reduces the risk of residual artifacts from highly accelerated undersampling (8.5-fold), (3) it simplifies the reconstruction process by providing GRAPPA-reconstructed low-resolution images in real time, enabling real-time monitoring of contrast dynamics, and (4) the super-resolution process operates independently of the full temporal series, allow for efficient image-by-image processing and minimize the potential loss of temporal fidelity.

In the example embodiment, results showed higher temporal resolution compared to the clinically used GRAPPA-2, where the higher temporal resolution enables better capture of fast perfusion dynamics. This enhancement may reduce temporal blurring, provide more precise time-intensity curves for quantitative analysis, and allow for more accurate assessment of myocardial ischemia. Additionally, higher temporal resolution may mitigate motion artifacts caused by cardiac and respiratory motion, resulting in clearer images and potentially more reliable diagnostic outcomes.

The super-resolved output may not theoretically exceed the spatial resolution of the reference images used for training. A broader dataset would be beneficial for a more thorough model training. The generative model may produce artifacts in the images, and these artifacts may be mitigated through well-designed data augmentation strategies. These findings may be validated in larger datasets and varied clinical scenarios, particularly in the assessment of ischemic perfusion defects in stress perfusion MRI. Clinical validation may be used to assess the reliability of this approach. The super-resolution method may be combined with physics-guided, self-supervised learning reconstruction networks for high-resolution perfusion MRI, and extend this approach with quantitative analysis.

Overall, embodiments disclosed herein show the capability of the conditional diffusion generative model in generation high-resolution myocardial perfusion MRI and demonstrates its feasibility to accelerate myocardial perfusion MRI acquisition, increase temporal resolution and slice coverage, and improve image quality without introducing significant artifacts or blurring.

Example embodiments of systems and methods for cardiac strain measurement are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” and/or “substantially” as applied to a particular value of a range applies to both values, and unless otherwise dependent on the precision of the instrument measuring the value, may indicate +/−10% of the stated value(s).

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method of generating high-resolution medical images of a subject, the method comprising:
receiving at least one low-resolution medical image, the at least one low-resolution medical image having a first resolution of acquisition;
generating, via a denoising machine learning model in a denoising diffusion probabilistic model, at least one high-resolution medical image based on the at least one low-resolution medical image, the at least one high-resolution medical image having a second resolution of acquisition higher than the first resolution, wherein the denoising diffusion probabilistic model includes:
a forward diffusion sub-model configured to transform an input high-resolution medical image into a noise image by adding noise to an output forward image from a prior iteration in a plurality of first iterations; and
a reverse diffusion sub-model including the denoising machine learning model, the reverse diffusion sub-model configured to reconstruct the input high-resolution medical image via the denoising machine learning model in a plurality of second iterations based on the noise image while being conditioned by a conditioning low-resolution image, wherein in each second iteration of the plurality of second iterations, the reverse diffusion sub-model is configured to denoise, via the denoising machine learning model, an output reverse image from a prior iteration conditioned by the conditioning low-resolution image,
wherein generating the at least one high-resolution medical image further comprises:
inputting the at least one low-resolution medical image into the denoising machine learning model; and
generating the at least one high-resolution medical image as at least one output from the denoising machine learning model; and
outputting the at least one high-resolution medical image,
wherein the at least one low-resolution image is a cardiac magnetic resonance (MR) image.

2. The method of claim 1, wherein generating the at least one high-resolution medical image further comprises:
cascading, in a plurality of stages, the generating by:
in each stage,
inputting at least one output stage image from a prior stage into the denoising machine learning model; and
generating at least one increased-resolution image as the at least one output from the denoising machine learning model,
wherein the at least one high-resolution medical image is the at least one output stage image at a final stage.

3. The method of claim 1 further comprising:
training the denoising machine learning model using a training image dataset, wherein the training image dataset includes low-resolution training images and corresponding high-resolution training images, the corresponding high-resolution training images being ground truth in training, wherein the low-resolution training images are generated by removing peripheral phase-encoding k-space data of the corresponding high-resolution training images.

4. The method of claim 3, wherein 70 percent of the peripheral phase-encoding k-space data are removed in generating the low-resolution training images.

5. The method of claim 1, wherein the at least one low-resolution medical image is a tagging MR image.

6. The method of claim 1, wherein the at least one low-resolution medical image is a perfusion MR image.

7. The method of claim 1, wherein generating the at least one high-resolution medical image further comprises:
generating the at least one high-resolution medical image while scanning a subject to acquire the at least one low-resolution medical image of the subject.

8. An image processing computing device for generating high-resolution medical images of a subject, the image processing computing device comprising at least one processor in communication with at least one memory device, the at least one processor programmed to:
receive at least one low-resolution medical image, the at least one low-resolution medical image having a first resolution of acquisition;
generate, via a denoising machine learning model in a denoising diffusion probabilistic model, at least one high-resolution medical image based on the at least one low-resolution medical image, the at least one high-resolution medical image having a second resolution of acquisition higher than the first resolution, wherein the denoising diffusion probabilistic model includes:
a forward diffusion sub-model configured to transform an input high-resolution medical image into a noise image by adding noise to an output forward image from a prior iteration in a plurality of first iterations; and
a reverse diffusion sub-model including the denoising machine learning model, the reverse diffusion sub-model configured to reconstruct the input high-resolution medical image via the denoising machine learning model in a plurality of second iterations based on the noise image while being conditioned by a conditioning low-resolution image, wherein in each second iteration of the plurality of second iterations, the reverse diffusion sub-model is configured to denoise, via the denoising machine learning model, an output reverse image from the prior iteration conditioned by the conditioning low-resolution image,
wherein generate the at least one high-resolution medical image further comprises:
input the at least one low-resolution medical image into the denoising machine learning model; and
generate the at least one high-resolution medical image as at least one output from the denoising machine learning model; and
output the at least one high-resolution medical image.

9. The image processing computing device of claim 8, wherein generate the at least one high-resolution medical image further comprises:
cascade, in a plurality of stages, the generating by:
in each stage,
inputting at least one output stage image from a prior stage into the denoising machine learning model; and
generating at least one increased-resolution image as the at least one output from the denoising machine learning model,
wherein the at least one high-resolution medical image is the at least one output stage image at a final stage.

10. The image processing computing device of claim 8, wherein the at least one processor is further programmed to:
train the denoising machine learning model using a training image dataset, wherein the training image dataset includes low-resolution training images and corresponding high-resolution training images, the corresponding high-resolution training images being ground truth in training, wherein the low-resolution training images are generated by removing peripheral phase-encoding k-space data of the corresponding high-resolution training images.

11. The image processing computing device of claim 10, wherein 70 percent of the peripheral phase-encoding k-space data are removed in generating the low-resolution training images.

12. The image processing computing device of claim 8, wherein the at least one low-resolution medical image is acquired without contrast agents.

13. The image processing computing device of claim 8, wherein the at least one low-resolution medical image is acquired with contrast agents.

14. The image processing computing device of claim 8, wherein generate the at least one high-resolution medical image further comprises:
generate the at least one high-resolution medical image while scanning a subject to acquire the at least one low-resolution medical image of the subject.

15. One or more non-transitory computer-readable media for generating high-resolution medical images of a subject, the one or more non-transitory computer-readable media comprising one or more instructions stored thereon that, in response to being executed, cause a system to:
receive at least one low-resolution medical image, the at least one low-resolution medical image having a first resolution of acquisition;
generate, via a denoising machine learning model in a denoising diffusion probabilistic model, at least one high-resolution medical image based on the at least one low-resolution medical image, the at least one high-resolution medical image having a second resolution of acquisition higher than the first resolution, wherein the denoising diffusion probabilistic model includes:
a forward diffusion sub-model configured to transform an input high-resolution medical image into a noise image by adding noise to an output forward image from a prior iteration in a plurality of first iterations; and
a reverse diffusion sub-model including the denoising machine learning model, the reverse diffusion sub-model configured to reconstruct the input high-resolution medical image via the denoising machine learning model in a plurality of second iterations based on the noise image while being conditioned by a conditioning low-resolution image, wherein in each second iteration of the plurality of second iterations, the reverse diffusion sub-model is configured to denoise, via the denoising machine learning model, an output reverse image from a prior iteration conditioned by the conditioning low-resolution image,
wherein generate the at least one high-resolution medical image further comprises:
input the at least one low-resolution medical image into the denoising machine learning model; and
generate the at least one high-resolution medical image as at least one output from the denoising machine learning mode; and
output the at least one high-resolution medical image.

16. The one or more non-transitory computer-readable media of claim 15, wherein generate the at least one high-resolution medical image further comprises:
cascade, in a plurality of stages, the generating by:
in each stage,
inputting at least one output stage image from a prior stage into the denoising machine learning model; and
generating at least one increased-resolution image as the at least one output from the denoising machine learning model,
wherein the at least one high-resolution medical image is the at least one output stage image at a final stage.

17. The one or more non-transitory computer-readable media of claim 15, wherein the one or more instructions further cause the system to:
train the denoising machine learning model using a training image dataset, wherein the training image dataset includes low-resolution training images and corresponding high-resolution training images, the corresponding high-resolution training images being ground truth in training, wherein the low-resolution training images are generated by removing peripheral phase-encoding k-space data of the corresponding high-resolution training images.

18. The one or more non-transitory computer-readable media of claim 17, wherein 70 percent of the peripheral phase-encoding k-space data are removed in generating the low-resolution training images.

19. The one or more non-transitory computer-readable media of claim 15, wherein the at least one low-resolution medical image is a tagging magnetic resonance (MR) image.

20. The one or more non-transitory computer-readable media of claim 15, wherein the one or more instructions further cause the system to:
generate the at least one high-resolution medical image while scanning a subject to acquire the at least one low-resolution medical image of the subject.
